(19) United States
(12) Patent Application Publication
(10) Pub. No.: US 2026/0304513 A1
(43) Pub. Date: Oct. 1, 2026

(54) Creating and Using Device Groups During Direct-to-Cell Satellite Coverage

(71) Applicants: AT&T Mobility II LLC, Atlanta, GA (US); AT&T Intellectual Property I, L.P., Atlanta, GA (US)

(72) Inventors: Nathan Stowell, Lake Stevens, WA (US); Zhengyi Zhou, Chappaqua, NY (US); Rashmi Palamadai, Naperville, IL (US); Yupeng Jia, South Pasadena, CA (US)

(73) Assignees: AT&T Mobility II LLC, Atlanta, GA (US); AT&T Intellectual Property I, L.P., Atlanta, GA (US)

(21) Appl. No.: 19/096,822

(22) Filed: Apr. 1, 2025

(51) Int. Cl. H04W 76/14; H04W 48/08; H04W 84/06

(52) U.S. Cl. CPC H04W 76/14; H04W 48/08; H04W 84/06

(57) ABSTRACT

Creating and using device groups during direct-to-cell satellite coverage can include detecting a current network connection of a user device; broadcasting, at the user device and using a peer-to-peer wireless technology, availability of a shared direct-to-cell satellite network connection; receiving, from a group device, a request to access the shared direct-to-cell satellite network connection, where the group device is not connected to the direct-to-cell satellite network. In response to determining that the request to access the shared direct-to-cell satellite network connection is approved, a device group is created, the device group including the user device and the group device, a peer-to-peer network is established between the user device and the group device, and data from the group device is sent by the user device to a resource via the direct-to-cell satellite network connection.

### BACKGROUND

Some modern computing devices such as smartphones, smartwatches, vehicle computing systems, and the like, can include multiple transceivers for conducting communications over one or more networks. At some times, tracking what network a device is communicating with can be complicated, and because network conditions can change rapidly, it may be difficult for a user to stay informed about current connections, connection statuses, and/or connection options at any given time.

### SUMMARY

The present disclosure is directed to creating and using device groups during direct-to-cell satellite coverage. A user device can be connected to a wireless network such as a WiFi network, a cellular network, combinations thereof, or the like. The user device can move out of a coverage area associated with the wireless network at some time. At another time, the user device can move into a satellite coverage area associated with a direct-to-cell satellite network. The user device can be configured to communicate via the direct-to-cell satellite network. A group device can be in proximity to the user device. As used herein, the group device and the user device can be referred to as being “in proximity to” one another if the user device and/or the group device are within direct communication range of one another using a short-range peer-to-peer wireless technology, which to communicate between the user device and the group device. Short-range peer-to-peer wireless technologies that can be used in embodiments of the concepts and technologies disclosed herein can include, but are not necessarily limited to, technologies such as WiFi, Bluetooth, near-field communication (“NFC”), and the like, which can be used to establish a peer-to-peer network between the user device and the group device (and/or other devices that collectively can provide a device group as illustrated and described herein). It should be understood that this example embodiment is illustrative, and therefore should not be construed as being limiting in any way.

It can be appreciated that not all devices may be equipped, enabled, and/or able to access a direct-to-cell satellite network at some time (e.g., the devices may not have the appropriate hardware, cases or power levels may prevent connecting, or the like). Thus, embodiments of the concepts and technologies disclosed herein can include the user device connecting to the direct-to-cell satellite network and being configured to share this connection. In particular, by executing a connection sharing application, the user device can share the direct-to-cell satellite network connection with other devices. The user device can query devices in proximity to the user device (e.g., in range as explained herein) and offer to share the direct-to-cell satellite network connection provided by the direct-to-cell satellite network. One or more devices may accept the invitation to access the shared direct-to-cell satellite network connection. These communications can include presenting options on user interfaces of the user device and/or the group device, and communicating to offer and/or accept sharing of the direct-to-cell satellite network connection. It should be understood that this example embodiment is illustrative, and therefore should not be construed as being limiting in any way.

The user device can be configured to share the direct-to-cell satellite network connection with other devices in the device group (e.g., the group device) in several manners. In some embodiments, the user device can receive group device data form the group device via the peer-to-peer network. The group device data can include application data from the group device that is to be provided to a resource (e.g., a remote application server, website, or the like). The resource can be remote from the peer-to-peer network, the user device, and the group device, but accessible to the user device via the direct-to-cell satellite network and/or other connections (e.g., via the network, the server computer, and the like). The user device can create group data, which can include the group device data and optionally data from other devices in the device group. The user device can transmit the group data to the resource (or can direct data to the resource via one or more other devices and/or networks such as the server computer). It should be understood that this example embodiment is illustrative, and therefore should not be construed as being limiting in any way.

The server computer or other device can be configured to obtain the group data, extract one or more instances of resource data for providing to one or more of the resources, and provide the resource data to the resources. The resources can process the resource data as if received from the group device and respond with another instance of the resource data. The server computer or other device can create another instance of the group data and provide the group data back to the user device. The user device can be configured to extract, from the group data, another instance of group device data and provide the other instance of the group device data to the group device via the peer-to-peer network. It should be understood that this example embodiment is illustrative, and therefore should not be construed as being limiting in any way. In some embodiments, the user device can also be configured to obtain, from devices in the device group such as the group device, biometric data that can be obtained by biometric sensors at the group device. Other information can be obtained by the user device from the group device such as, for example, contacts, health information, or the like, which the group device may have selected for sharing via the connection sharing application installed at the group device. The user device can provide the biometric data to the server computer, which can be configured to perform operations to prioritize group traffic based on the biometric data in some instances. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include detecting a current network connection of a user device, the current network connection can include a direct-to-cell satellite network connection provided by a direct-to-cell satellite network; broadcasting, at the user device and using a peer-to-peer wireless technology, availability of a shared direct-to-cell satellite network connection; and receiving, at the user device and from a group device, a request to access the shared direct-to-cell satellite network connection. The group device can be located in proximity to the user device, and the group device is not connected to the direct-to-cell satellite network. The operations further can include in response to determining that the request to access the shared direct-to-cell satellite network connection is approved, creating a device group that includes the user device and the group device, establishing a peer-to-peer network between the user device and the group device, and sharing the shared direct-to-cell satellite network connection with the group device via the peer-to-peer network; obtaining, by the user device and from the group device via the peer-to-peer network, group device data that corresponds to application data associated with the group device and a resource operating in communication with a network; and sending, by the user device and directed to the resource via the direct-to-cell satellite network connection, group data that can include the group device data.

In some embodiments, the operations further can include generating, at the user device, device data that can include identity data that can identify the user device, connection data that can indicate that the user device is connected to the direct-to-cell satellite network connection, and group member data that can identify the user device as a first member of the device group and the group device as a second member of the device group; and sending, to a coverage management service and via the direct-to-cell satellite network connection, the device data. The coverage management service can update a first record that is associated with the user device to include first group information that can identify the user device as the first member of the device group, and the coverage management service can update a second record that is associated with the group device to include second group information that can identify the group device as the second member of the device group.

In some embodiments, the operations further can include obtaining, by the user device and from the group device via the peer-to-peer network, biometric data captured by biometric sensors of the group device; and sending, by the user device and to a coverage management service via the direct-to-cell satellite network connection, the biometric data. The coverage management service can be configured to determine, based on the biometric data, that group traffic should be prioritized, and to deliver a command to the direct-to-cell satellite network associated with the direct-to-cell satellite network connection to prioritize the group traffic. In some embodiments, the operations further can include receiving, by the user device via the direct-to-cell satellite network connection, another instance of group data that can include other application data that is associated with the group device and the resource; extracting, by the user device and from the other instance of group data, another instance of group device data; and sending, by the user device and to the group device via the peer-to-peer network, the other instance of group device data.

In some embodiments, sending the group data directed to the resource can include sending, by the user device and to a server computer via the direct-to-cell satellite network connection, the group data. A connection management service can be hosted by the server computer, and the connection management service can be configured to exchange communications with the resource. In some embodiments, the operations further can include presenting, at the user device, a user interface that can include an indication that the user device is connected to the direct-to-cell satellite network connection, and an option to share the direct-to-cell satellite network connection with the group device. In some embodiments, the operations further can include presenting, at the user device, a user interface that can include an indication that the user device is connected to the direct-to-cell satellite network connection, and an option to share applications with the group device. The group device can be configured to execute the applications and to generate data that is transmitted, by the user device, via the direct-to-cell satellite network connection.

According to another aspect of the concepts and technologies disclosed herein, a method is disclosed. The method can include detecting a current network connection of a user device, the current network connection can include a direct-to-cell satellite network connection provided by a direct-to-cell satellite network; broadcasting, at the user device and using a peer-to-peer wireless technology, availability of a shared direct-to-cell satellite network connection; and receiving, at the user device and from a group device, a request to access the shared direct-to-cell satellite network connection. The group device can be located in proximity to the user device, and the group device is not connected to the direct-to-cell satellite network. The method further can include in response to determining that the request to access the shared direct-to-cell satellite network connection is approved, creating a device group that includes the user device and the group device, establishing a peer-to-peer network between the user device and the group device, and sharing the shared direct-to-cell satellite network connection with the group device via the peer-to-peer network; obtaining, by the user device and from the group device via the peer-to-peer network, group device data that corresponds to application data associated with the group device and a resource operating in communication with a network; and sending, by the user device and directed to the resource via the direct-to-cell satellite network connection, group data that can include the group device data.

In some embodiments, the method further can include generating, at the user device, device data that can include identity data that can identify the user device, connection data that can indicate that the user device is connected to the direct-to-cell satellite network connection, and group member data that can identify the user device as a first member of the device group and the group device as a second member of the device group; and sending, to a coverage management service and via the direct-to-cell satellite network connection, the device data. The coverage management service can update a first record that is associated with the user device to include first group information that can identify the user device as the first member of the device group, and the coverage management service can update a second record that is associated with the group device to include second group information that can identify the group device as the second member of the device group.

In some embodiments, the method further can include obtaining, by the user device and from the group device via the peer-to-peer network, biometric data captured by biometric sensors of the group device; and sending, by the user device and to a coverage management service via the direct-to-cell satellite network connection, the biometric data. The coverage management service can be configured to determine, based on the biometric data, that group traffic should be prioritized, and to deliver a command to the direct-to-cell satellite network associated with the direct-to-cell satellite network connection to prioritize the group traffic. In some embodiments, the method further can include receiving, by the user device via the direct-to-cell satellite network connection, another instance of group data that can include other application data that is associated with the group device and the resource; extracting, by the user device and from the other instance of group data, another instance of group device data; and sending, by the user device and to the group device via the peer-to-peer network, the other instance of group device data.

In some embodiments, sending the group data directed to the resource can include sending, by the user device and to a server computer via the direct-to-cell satellite network connection, the group data. A connection management service can be hosted by the server computer, and the connection management service can be configured to exchange communications with the resource. In some embodiments, the method further can include presenting, at the user device, a user interface that can include an indication that the user device is connected to the direct-to-cell satellite network connection, and an option to share the direct-to-cell satellite network connection with the group device. In some embodiments, the method further can include presenting, at the user device, a user interface that can include an indication that the user device is connected to the direct-to-cell satellite network connection, and an option to share applications with the group device. The group device can be configured to execute the applications and to generate data that is transmitted, by the user device, via the direct-to-cell satellite network connection.

According to yet another aspect of the concepts and technologies disclosed herein, a computer storage medium is disclosed. The computer storage medium can store computer-executable instructions that, when executed by a processor, cause the processor to perform operations. The operations can include detecting a current network connection of a user device, the current network connection can include a direct-to-cell satellite network connection provided by a direct-to-cell satellite network; broadcasting, at the user device and using a peer-to-peer wireless technology, availability of a shared direct-to-cell satellite network connection; and receiving, at the user device and from a group device, a request to access the shared direct-to-cell satellite network connection. The group device can be located in proximity to the user device, and the group device is not connected to the direct-to-cell satellite network. The operations further can include in response to determining that the request to access the shared direct-to-cell satellite network connection is approved, creating a device group that includes the user device and the group device, establishing a peer-to-peer network between the user device and the group device, and sharing the shared direct-to-cell satellite network connection with the group device via the peer-to-peer network; obtaining, by the user device and from the group device via the peer-to-peer network, group device data that corresponds to application data associated with the group device and a resource operating in communication with a network; and sending, by the user device and directed to the resource via the direct-to-cell satellite network connection, group data that can include the group device data.

In some embodiments, the operations further can include generating, at the user device, device data that can include identity data that can identify the user device, connection data that can indicate that the user device is connected to the direct-to-cell satellite network connection, and group member data that can identify the user device as a first member of the device group and the group device as a second member of the device group; and sending, to a coverage management service and via the direct-to-cell satellite network connection, the device data. The coverage management service can update a first record that is associated with the user device to include first group information that can identify the user device as the first member of the device group, and the coverage management service can update a second record that is associated with the group device to include second group information that can identify the group device as the second member of the device group.

In some embodiments, the operations further can include obtaining, by the user device and from the group device via the peer-to-peer network, biometric data captured by biometric sensors of the group device; and sending, by the user device and to a coverage management service via the direct-to-cell satellite network connection, the biometric data. The coverage management service can be configured to determine, based on the biometric data, that group traffic should be prioritized, and to deliver a command to the direct-to-cell satellite network associated with the direct-to-cell satellite network connection to prioritize the group traffic. In some embodiments, the operations further can include receiving, by the user device via the direct-to-cell satellite network connection, another instance of group data that can include other application data that is associated with the group device and the resource; extracting, by the user device and from the other instance of group data, another instance of group device data; and sending, by the user device and to the group device via the peer-to-peer network, the other instance of group device data.

In some embodiments, sending the group data directed to the resource can include sending, by the user device and to a server computer via the direct-to-cell satellite network connection, the group data. A connection management service can be hosted by the server computer, and the connection management service can be configured to exchange communications with the resource. In some embodiments, the operations further can include presenting, at the user device, a user interface that can include an indication that the user device is connected to the direct-to-cell satellite network connection, and an option to share the direct-to-cell satellite network connection with the group device. In some embodiments, the operations further can include presenting, at the user device, a user interface that can include an indication that the user device is connected to the direct-to-cell satellite network connection, and an option to share applications with the group device. The group device can be configured to execute the applications and to generate data that is transmitted, by the user device, via the direct-to-cell satellite network connection.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIGS. 1A-1B are system diagrams illustrating aspects of an illustrative operating environment for various embodiments of the concepts and technologies described herein.

FIG. 2 is a flow diagram showing aspects of a method for creating and using a device group during direct-to-cell satellite coverage, according to an illustrative embodiment of the concepts and technologies described herein.

FIG. 3 is a flow diagram showing aspects of a method for exchanging data within a device group during direct-to-cell satellite coverage, according to an illustrative embodiment of the concepts and technologies described herein.

FIG. 4 is a flow diagram showing aspects of a method for detecting a device group during direct-to-cell satellite coverage, according to an illustrative embodiment of the concepts and technologies described herein.

FIG. 5 is a flow diagram showing aspects of a method for providing data to devices of a device group during direct-to-cell satellite coverage, according to an illustrative embodiment of the concepts and technologies described herein.

FIGS. 6A-6D are user interface diagrams showing various screen displays for creating and using device groups during direct-to-cell satellite coverage, according to some illustrative embodiments of the concepts and technologies described herein.

FIG. 7 schematically illustrates a network, according to an illustrative embodiment of the concepts and technologies described herein.

FIG. 8 is a block diagram illustrating an example computer system configured to enable creating and using device groups during direct-to-cell satellite coverage, according to some illustrative embodiments of the concepts and technologies described herein.

FIG. 9 is a block diagram illustrating an example mobile device configured to interact with a coverage management service, according to some illustrative embodiments of the concepts and technologies described herein.

FIG. 10 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to creating and using device groups during direct-to-cell satellite coverage. A user device can be connected to a wireless network such as a WiFi network, a cellular network, combinations thereof, or the like. The user device can move out of a coverage area associated with the wireless network at some time. At another time, the user device can move into a satellite coverage area associated with a direct-to-cell satellite network. The user device can be configured to communicate via the direct-to-cell satellite network. A group device can be in proximity to the user device. As used herein, the group device and the user device can be referred to as being “in proximity to” one another if the user device and/or the group device are within direct communication range of one another using a short-range peer-to-peer wireless technology to communicate between the user device and the group device. Short-range peer-to-peer wireless technologies that can be used in embodiments of the concepts and technologies disclosed herein can include, but are not necessarily limited to, technologies such as WiFi, Bluetooth, NFC, and the like, which can be used to establish a peer-to-peer network between the user device and the group device (and/or other devices that collectively can provide a device group as illustrated and described herein). It should be understood that this example embodiment is illustrative, and therefore should not be construed as being limiting in any way.

It can be appreciated that not all devices may be equipped, enabled, and/or able to access a direct-to-cell satellite network at some time (e.g., the devices may not have the appropriate hardware, cases or power levels may prevent connecting, or the like). Thus, embodiments of the concepts and technologies disclosed herein can include the user device connecting to the direct-to-cell satellite network and being configured to share this connection. In particular, by executing a connection sharing application, the user device can share the direct-to-cell satellite network connection with other devices. The user device can query devices in proximity to the user device (e.g., in range as explained herein) and offer to share the direct-to-cell satellite network connection provided by the direct-to-cell satellite network. One or more devices may accept the invitation to access the shared direct-to-cell satellite network connection. These communications can include presenting options on user interfaces of the user device and/or the group device, and communicating to offer and/or accept sharing of the direct-to-cell satellite network connection. It should be understood that this example embodiment is illustrative, and therefore should not be construed as being limiting in any way.

The user device can be configured to share the direct-to-cell satellite network connection with other devices in the device group (e.g., the group device) in several manners. In some embodiments, the user device can receive group device data from the group device via the peer-to-peer network. The group device data can include application data from the group device that is to be provided to a resource (e.g., a remote application server, website, or the like). The resource can be remote from the peer-to-peer network, the user device, and the group device, but accessible to the user device via the direct-to-cell satellite network and/or other connections (e.g., via the network, the server computer, and the like). The user device can create group data, which can include the group device data and optionally data from other devices in the device group. The user device can transmit the group data to the resource (or can direct data to the resource via one or more other devices and/or networks such as the server computer). It should be understood that this example embodiment is illustrative, and therefore should not be construed as being limiting in any way.

The server computer or other device can be configured to obtain the group data, extract one or more instances of resource data for providing to one or more of the resources, and provide the resource data to the resources. The resources can process the resource data as if received from the group device and respond with another instance of the resource data. The server computer or other device can create another instance of the group data and provide the group data back to the user device. The user device can be configured to extract, from the group data, another instance of group device data and provide the other instance of the group device data to the group device via the peer-to-peer network. It should be understood that this example embodiment is illustrative, and therefore should not be construed as being limiting in any way. In some embodiments, the user device can also be configured to obtain, from devices in the device group such as the group device, biometric data that can be obtained by biometric sensors at the group device. Other information can be obtained by the user device from the group device such as, for example, contacts, health information, or the like, which the group device may have selected for sharing via the connection sharing application installed at the group device. The user device can provide the biometric data to the server computer, which can be configured to perform operations to prioritize group traffic based on the biometric data in some instances. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

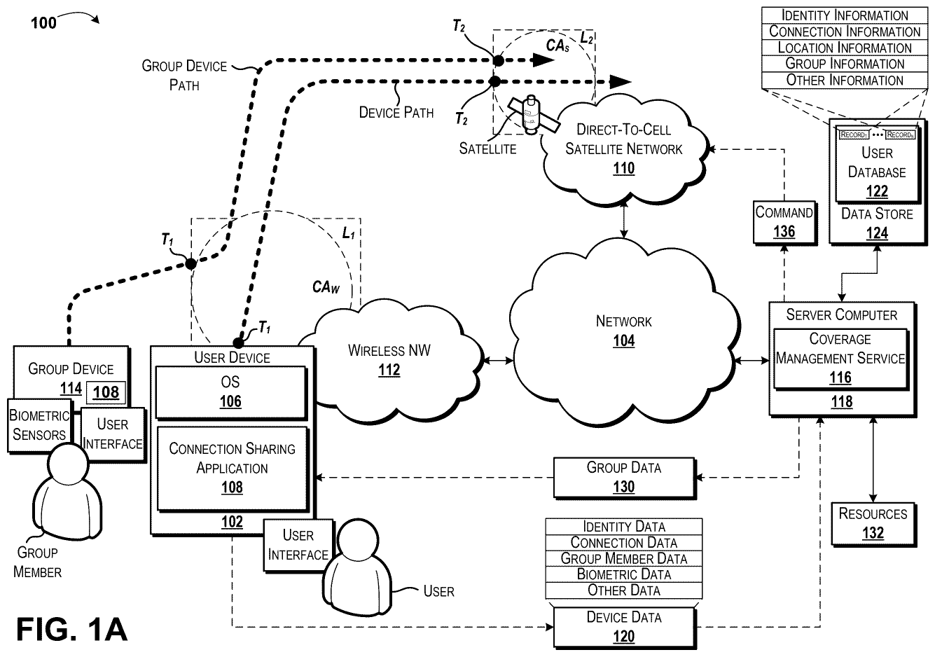

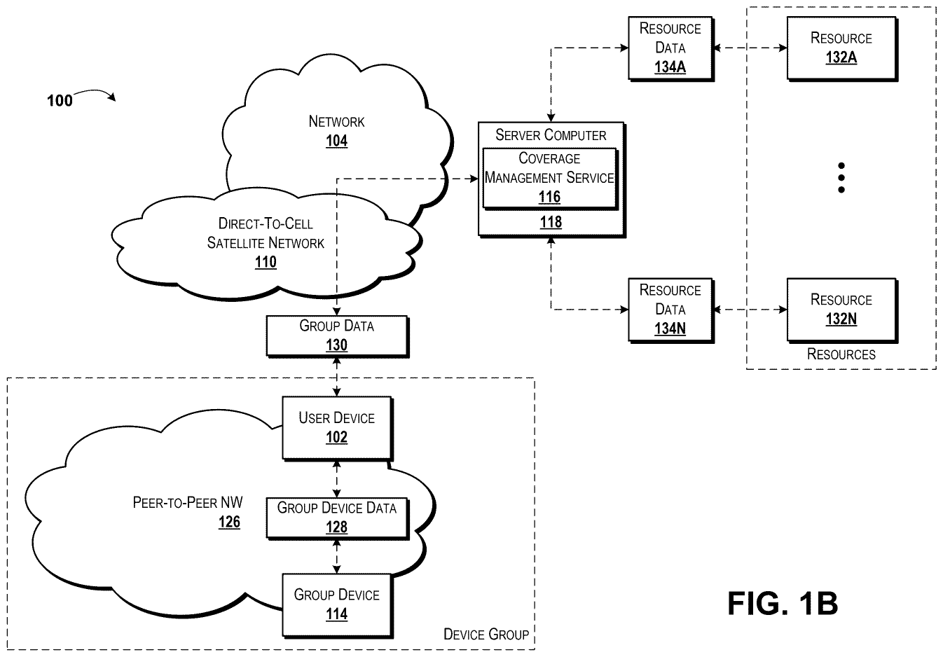

Referring now to FIGS. 1A-1B, aspects of an operating environment 100 for various embodiments of the concepts and technologies disclosed herein for creating and using device groups during direct-to-cell satellite coverage will be described, according to an illustrative embodiment. The operating environment 100 shown in FIGS. 1A-1B includes a user device 102. The user device 102 can operate in communication with and/or as part of one or more communications networks such as, for example, a communications network (“network”) 104, though this is not necessarily the case in all embodiments. As will be further explained herein, the network 104 can be accessed in various embodiments by one or more other networks, subnetworks, portals, or the like. Similarly, the user device 102 may connect to the network 104 directly, through or via these other networks, subnetworks, portals, or the like in various embodiments. These and other aspects of the operating environment 100 will be explained in more detail hereinbelow after introducing the various components of the operating environment 100.

According to various embodiments, the functionality of the user device 102 may be provided by one or more mobile telephones or smartphones, laptop computers, tablet computers, vehicle computing systems, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can be configured to execute an operating system 106 and one or more application programs such as, for example, a connection sharing application 108. The operating system 106 can include a computer program that can control the operation of the user device 102. The connection sharing application 108 can include an executable program that can be configured to execute on top of the operating system 106 to provide various functions as illustrated and described herein for creating and using device groups during direct-to-cell satellite coverage as illustrated and described herein.

In various embodiments, the connection sharing application 108 can be configured to detect one or more network connections of the user device 102; to update one or more entities regarding the one or more network connections of the user device 102 (as will be illustrated and described herein in more detail below); to receive one or more notifications or other communications and update user interfaces based on those communications; to search for other devices in a proximity of the user device 102; to add other devices to a device group; to communicate with remote devices for various reasons for the user device 102 and/or other devices in the device group; combinations thereof; or the like. These and/or other functions of the connection sharing application 108 will be illustrated and described herein after introducing additional entities operating in and/or associated with the operating environment 100.

In the illustrated embodiment shown in FIG. 1A, the user device 102 can be configured to communicate with the network 104 directly and/or through a direct-to-cell satellite network 110; a cellular network and/or other wireless network such as a WiFi network (hereinafter referred to as a “wireless network”) 112; a vehicle-to-vehicle or other peer-to-peer network; other networks; combinations thereof; or the like. As is generally understood, capabilities (e.g., bandwidth, latency, upload speed, download speed, etc.) of network connections associated with these networks, subnetworks, and/or other networking connections such as, for example, the network 104, the direct-to-cell satellite network 110, the wireless network 112, or the like, can vary. For example, capabilities of these and/or other connections may vary based on time and/or proximity of the user device 102 to hardware associated with these connections, limitations of hardware that provides these connections, and/or based on other factors. According to various embodiments of the concepts and technologies disclosed herein, the connection sharing application 108 can be configured to create, update, and use information that indicates how the user device 102 is connected to one or more of these networks for various reasons as illustrated and described herein, which will be illustrated and described herein in more detail.

As shown in the illustrated example embodiment shown in FIG. 1A, the user device 102 can connect to the wireless network 112 at a first time T₁ and while located at or in proximity to a first area or geographic location (hereinafter first location L₁) such as a home, a business, a vehicle, or the like. In some embodiments, the user device 102 can be configured to access the network 104 and/or other networks via the wireless network 112 at various times and/or locations including, but not limited to, the first time T₁ while at or near the first location L₁. In various embodiments, as illustrated in FIG. 1A, the wireless network 112 can have an associated wireless network coverage area CA_{W} that can correspond to a communication range in which the user device 102 can communicate with the wireless network 112 and/or hardware thereof such as a radio unit (“RU”), a WiFi router or gateway, or the like. In various embodiments of the concepts and technologies disclosed herein, the wireless network coverage area CA_{W} can partially and/or completely overlap and/or can be encompassed within boundaries of the first location L₁, though this is not necessarily the case in all embodiments. As such, it should be understood that this example embodiment is illustrative, and therefore should not be construed as being limiting in any way.

The user device 102 also can be configured to access the wireless network 112 (e.g., a cellular network or the like) using cellular technology as is generally understood. For example, the user device 102 can be configured to communicate with the wireless network 112 to negotiate a connection and/or to be provisioned with cellular network connectivity using a cellular transceiver and/or other functionality as is generally understood. It should also be noted that the user device 102 also can be configured to connect to the direct-to-cell satellite network 110 using a cellular transceiver and/or other hardware of the user device 102, or using dedicated hardware in some embodiments. It should be understood that this example embodiment is illustrative, and therefore should not be construed as being limiting in any way.

According to various embodiments of the concepts and technologies disclosed herein, the connection sharing application 108 can be configured to detect one or more network connections between the user device 102 and the one or more of the networks 104, 110, 112; to communicate with other entities relating to the one or more network connections of the user device 102; to create and/or update user interfaces at the user device 102 to reflect current, future, and/or shared network connections and/or other information as illustrated and described herein; to create device groups including the user device 102 and one or more group devices 114; to share a network connection with one or more group devices 114; to manage communications occurring over shared network connections (e.g., for the group devices 114); to enable access to applications among and/or between the devices in the device groups (e.g., the user device 102 and the group devices 114); to perform other functions as illustrated and described herein; combinations thereof; or the like. As shown in FIG. 1A, the group devices 114 also can execute a connection sharing application 108. Alternatively, the functionality of the connection sharing application 108 can be included in an operating system of the group device 114. It also should be understood that the functionality of the connection sharing application 108 of the user device 102 can be incorporated into the operating system 106 in some embodiments. It should be understood that this example embodiment is illustrative, and therefore should not be construed as being limiting in any way.

According to various embodiments of the concepts and technologies disclosed herein, the functionality of the group device 114 may be provided by one or more mobile telephones or smartphones, laptop computers, tablet computers, vehicle computing systems, other computing systems, and the like. It should be understood that the functionality of the group device 114 may be provided by a single device, by two or more similar devices, and/or by two or more dissimilar devices. For purposes of describing the concepts and technologies disclosed herein, the group device 114 is described herein as a smartphone. It should be understood that this embodiment is illustrative, and should not be construed as being limiting in any way.

The connection sharing application 108 can be configured to monitor one or more transceivers and/or other hardware of the user device 102 and/or the group device 114 (e.g., a WiFi transceiver, a Bluetooth transceiver, a cellular transceiver, a physical connection port, or the like) to determine and/or identify one or more network connections currently available to and/or active at the user device 102 and/or the group device 114. The connection sharing application 108 also can be configured to survey a proximity of the user device 102 and/or the group device 114 to detect devices that can be added to a device group. According to various embodiments, a device that executes the connection sharing application 108 can be added to the device group. It should be understood that this example embodiment is illustrative, and therefore should not be construed as being limiting in any way. The connection sharing application 108 also can be configured to report the connections of the user device 102 and/or the group device 114 to one or more other entities, as will be explained in more detail herein.

According to various embodiments of the concepts and technologies disclosed herein, the group device 114 may be connected to the wireless network 112 at the first time T₁ and while at the first location L₁, but may lose all network connections at a second time T₂ and/or at a second location L₂ as will be explained in more detail below. As such, the communications between the user device 102 will be explained in more detail and can apply to the group device 114 when connected to some network connections as illustrated and described herein.

The user device 102, the group device 114, and other devices that execute the connection sharing application 108 can be configured to communicate with a coverage management service 116 to report network connections and/or other information for various purposes. The functionality of the coverage management service 116 can be provided by an application, program, module, service, or the like; which can be hosted and/or executed by a computing device such as a server computer 118. In various embodiments, the functionality of the server computer 118 can be provided by an application server, a web server, or the like. The functionality of the server computer 118 may be provided by a single device, by two or more similar devices, and/or by two or more dissimilar devices (e.g., by a single server computer, by a cloud-based server computer, by one or more virtual resources, or the like). For purposes of describing the concepts and technologies disclosed herein, the server computer 118 is described herein as an application server that can host and/or execute the coverage management service 116. It should be understood that this example embodiment is illustrative, and therefore should not be construed as being limiting in any way.

In various embodiments of the concepts and technologies disclosed herein, the coverage management service 116 can determine what connection(s) are active at the user device 102, the group device 114, and/or other devices. This determination can be made by the coverage management service 116, in some embodiments, based on device data 120, which can be generated by the user device 102, the group device 114, or other devices, and obtained by the coverage management service 116 at various times. The device data 120 will be explained in more detail below. To avoid obscuring the description of FIGS. 1A-1B, the device data 120 is illustrated as being sent by the user device 102, but based on the above it can be appreciated that the group device 114 also can generate the device data 120 and provide device data 120 to the coverage management service 116 in some embodiments. Based on the device data 120 or other information obtained by the coverage management service 116, the coverage management service 116 can be configured to identify one or more networks and/or network resources connected to by the user device 102 and/or the group device 114 at any particular time. It should be understood that this example embodiment is illustrative, and therefore should not be construed as being limiting in any way.

As shown in FIG. 1A, the user device 102 and the group device 114 may or may not be stationary. In the example shown in FIG. 1A, the user device 102 may move along a device path and the group device 114 may move along a group device path. In the illustrated embodiment, these devices move along a similar path, but it can be appreciated that this example is illustrative only and should not be construed as being limiting in any way. In FIG. 1A, the user device 102 and the group device 114 can enter and/or be located at the first location L₁ (and can be within a wireless network coverage area CA_{W}) at the first time T₁; depart from the first location L₁ (and the wireless network coverage area CA_{W}) at some time and may move along respective paths (the user device 102 along the device path and the group device 114 along the group device path); and may enter and/or be located at the second location L₂ at a second time T₂. As shown in FIG. 1A, the user device 102 and the group device 114 can be located within a satellite coverage area CA_{S} of a satellite of the direct-to-cell satellite network 110 at the second location L₂ at a second time T₂. In the example embodiment, however, the user device 102 can be enabled for communication via the direct-to-cell network 110 and the group device 114 may not be enabled for communications via the direct-to-cell satellite network 110. Thus, it can be appreciated from the example embodiment that the user device 102 and the group device 114 may connect to the wireless network 112 at a first time T₁, while only the user device 102 may be enabled for connection to the direct-to-cell satellite network 110 at the second time T₂. It should be understood that this example embodiment is illustrative, and therefore should not be construed as being limiting in any way.

According to various embodiments of the concepts and technologies disclosed herein, the user device 102 and/or the group device 114 can be configured to collect connection information that identifies a current network connection and to provide this and other information to the coverage management service 116 as part of the device data 120. The device data 120 can be provided to the coverage management service 116 (when network connections are available) in real-time (e.g., as connections change), proactively (e.g., before connections change), at other times, combinations thereof, or the like. According to various embodiments of the concepts and technologies disclosed herein, various instances of the device data 120 can include, but are not limited to, identity data, connection data, group member data, biometric data, and/or other data, any and/or all of which may be associated with the device that generates the device data 120 (e.g., the user device 102, the group device 114, or other device). It can be appreciated that in some embodiments, the device data 120 may not include all of these types of information. It should be understood that this example embodiment is illustrative, and therefore should not be construed as being limiting in any way.

According to various embodiments of the concepts and technologies disclosed herein, the identity data can identify the device that is generating the device data 120 (e.g., the user device 102 or the group device 114) and/or a user thereof. Thus, for example, the identity data can include, but is not limited to, a device identifier such as an International Mobile Subscriber Identity (“IMSI”), an International Mobile Equipment Identity (“IMEI”), a Permanent Equipment Identifier (“PEI”), a media access control identifier (“MAC ID”), a serial number, an Internet protocol (“IP”) address, a web identifier (“WebID”), additional and/or alternative device identifiers, combinations thereof, or the like. The identity data also can identify a user of the device such as a login, name, email address, a phone number, a unique identifier, combinations thereof, or the like. Because other information can identify devices and/or users thereof, it should be understood that these example embodiments are illustrative, and therefore should not be construed as being limiting in any way.

The connection data can identify, for the device generating the device data 120 one or more networks or network connections to and/or with which the device is connected and/or communicates. In various embodiments of the concepts and technologies disclosed herein, devices that generate the device data 120 can be configured to capture connection information by, for example, monitoring activity of one or more transceivers of the device (e.g., the user device 102 and/or the group device 114), with an active transceiver indicating that a network connection exists and/or is being used. In some embodiments, the connection data can be obtained from other entities (e.g., from a network reporting device, etc.). In any case, it can be appreciated that the connection sharing application 108 can be configured to collect and report the device data 120 to the coverage management service 116 in various embodiments. It should be understood that this example embodiment is illustrative, and therefore should not be construed as being limiting in any way.

The group member data can identify, for example, one or more group devices 114 that can be added or have been added to a device group with the user device 102. As shown in FIG. 1A, a group member can be associated with the group device 114. As will be illustrated and described in more detail herein, embodiments of the concepts and technologies disclosed herein can enable a user or other entity associated with the user device 102 to designate one or more group members (e.g., people, devices such as the group devices 114, or other entities) that can be or have been added to a device group. According to various embodiments of the concepts and technologies disclosed herein, the group member data can identify the group members, for example, using device identifiers and/or personal identifiers such as, for example, one or more IMSI, IMEI, PEI, MAC ID, IP address, WebID, name, telephone number, email address, login, other identifier, combinations thereof, or the like. As such, the group member data can include various identifiers as set forth above for the group member, the group device 114, or the like. It should be understood that this example embodiment is illustrative, and therefore should not be construed as being limiting in any way.

The biometric data can include, but is not limited to, biometric information captured by the group device 114 and/or biometric sensors thereof and/or in communication therewith. As such, the biometric data can include, for example, a heart rate of the group member; a fingerprint, face, retina, or other identifying physical characteristic of the group member; a heart rate, blood pressure, body temperature, oxygen saturation, or other condition associated with the group member; facial expressions associated with the group member; combinations thereof; or the like. Thus, it can be appreciated that the biometric sensors illustrated in FIG. 1A can include, but are not limited to, one or more thermometer or other temperature sensor, pulse oximeter, sphygmomanometer, camera or other imaging device, electrode, combinations thereof, or the like. As will be explained in more detail herein, the user device 102 can be configured to obtain the biometric data from devices in the device group (e.g., the group device 114) and to provide the biometric data to the coverage management service 116 in various embodiments. It should be understood that these example embodiments are illustrative, and therefore should not be construed as being limiting in any way.

The other data can include, for example, contextual information such as application and/or resource usage obtained from the user device 102 and/or the group device 114; information identifying one or more other users or devices in an immediate proximity of the user device 102 (e.g., the group device 114 and/or other devices); location data such as a current or expected geographic location associated with the user device 102 and/or the group device 114; or the like. It can be appreciated that the other data can include other information that can be used in some embodiments to project a location of the user device 102 and/or the group device 114 at some time in the future and/or for other purposes. It should be understood that these example embodiments are illustrative, and therefore should not be construed as being limiting in any way.

Based on the device data 120 and/or other information such as default settings or configurations, the coverage management service 116 can be configured to create, update, maintain, and/or modify user profiles or records (hereinafter collectively and/or generically referred to as “records”) for the user device 102 and/or for the group device 114. According to various embodiments of the concepts and technologies disclosed herein, the records (e.g., the illustrated example records labeled record₁, . . . , recordₙ) can be stored with records for other devices and/or users in and/or as a user database 122. According to various embodiments of the concepts and technologies disclosed herein, the user database 122 can be stored and/or hosted at a data store 124. The functionality of the data store 124 can be provided by one or more databases, server computers, data storage and/or host resources, other computing systems, and the like. In the illustrated embodiments, the data store 124 can be provided by a data server. In some embodiments, the data store 124 can correspond to a home subscriber server (“HSS”) and/or the like (e.g., a unified data management (“UDM”) and unified data repository (“UDR”)).

According to various embodiments, records for devices (e.g., the user device 102, the group device 114, or the like), can include, identity information (for the associated device and/or a user thereof), connection information that can indicate a current network connection and a signal strength associated therewith (e.g., low, medium, high and/or numerical measurements of signal strength); location information that can indicate a current geographic location of the associated device (e.g., using latitude, longitude, and elevation, or the like); group information that can indicate if the associated device is a member of a device group and/or a role in the device group (e.g., if the associated device is providing the network connection for the group devices or using a shared connection, or the like); other information; combinations thereof; or the like. It should be understood that this example embodiment is illustrative, and therefore should not be construed as being limiting in any way.

Thus, the records of the user database 122 can include, for example, identity information (e.g., a device identifier and/or user identifier) for a particular user or device (e.g., the user device 102 and/or a user thereof, the group device 114 and/or a group member associated therewith, or the like); connection information, which can represent or identify one or more active network connections for a device associated with the record (e.g., the user device 102, the group device 114, or the like); geolocation information (e.g., a current geographic location of the user device 102 and/or or the group device 114, a last known geographic location of the user device 102 and/or or the group device 114, or the like); membership of the associated device in a device group and/or a role in that device group; other information; combinations thereof; or the like. It can be appreciated that the user database 122 can include records for one or more or even all users associated with a particular network (e.g., the network 104, the direct-to-cell satellite network 110, the wireless network 112, or the like). It should be understood that this example embodiment is illustrative, and therefore should not be construed as being limiting in any way.

According to various embodiments of the concepts and technologies disclosed herein, the user database 122 can be created and updated by the coverage management service 116. The user database 122 also can be accessed by the coverage management service 116 at various times, for example when a release of device data 120 is received (e.g., to update the record, or the like). In particular, according to various embodiments of the concepts and technologies disclosed herein, the coverage management service 116 can be configured to determine, for a device such as the user device 102 and/or or the group device 114, one or more network connections that are available and/or are being used or accessed at some time. Based on this information, the coverage management service 116 can be configured to take various steps such as, for example, managing data delivery for the one or more devices associated with the records (e.g., the user device 102 and/or or the group device 114), managing prioritization of traffic associated with the user device 102 and/or or the group device 114, combinations thereof, or the like. These and other functions of the coverage management service 116 will be illustrated and described in more detail hereinbelow.

According to various embodiments of the concepts and technologies disclosed herein, the coverage management service 116 can be configured receive or otherwise obtain device data 120 at various times such as when a device that generated the device data 120 detects a network connection change (e.g., from one network to another, to one network without a backup connection to the same network with a backup connection, to one network with a backup connection to the same network without a backup connection, from a prioritized connection to a non-prioritized connection, from two or more network connections to one or more network connections, and the like). Because other changes in network connectivity are possible and are contemplated, it should be understood that these example embodiments are illustrative, and therefore should not be construed as being limiting in any way. In some other embodiments, the device data 120 can be provided to the server computer 118 at regular or irregular time intervals by the user device 102, the group device 114, or other device(s). In yet other embodiments, the device data 120 can be provided to the server computer 118 when requested by the server computer 118 or other devices or entities. In still other embodiments, the device data 120 can be provided to the server computer 118 when a user or other entity of the user device 102, the group device 114, or other device, enters a command or option to provide the device data 120 to the server computer 118. Because the device data 120 can be provided to the server computer 118 at additional and/or alternative times, it should be understood that these example embodiments are illustrative, and therefore should not be construed as being limiting in any way.

In some embodiments, the server computer 118 can be configured (e.g., via execution of the coverage management service 116) to analyze the device data 120 to determine an identity associated with the device data 120 (e.g., a user, device, or the like); to determine network connection information for the associated device such as a current network connection and/or signal strength thereof for the user device 102 or group device 114; to identify one or more devices in a device group and/or a proximity of the device that reported the device data 120; to determine biometric readings captured at the group device 114 (e.g., from a group member thereof); to determine a geographic location of the device that generated the device data 120 and/or other devices; combinations thereof; or the like. The coverage management service 116 can use these and/or other types of information included in the device data 120 to create, store, and/or update a record associated with the user device 102, and/or to use the updated record and/or data thereof to take various actions (e.g., to manage data delivery for the device group, to prioritize traffic associated with one or more devices in a device group (e.g., the user device 102, the group device 114, or the like), combinations thereof, or the like). It should be understood that this example embodiment is illustrative, and therefore should not be construed as being limiting in any way.

In some embodiments, the server computer 118 can be configured (e.g., via execution of the coverage management service 116) to use the records (after the records have been created) upon receiving an instance of device data 120. In particular, upon receiving a release or instance of device data 120, the server computer 118 can determine an identity associated with the device data 120 and retrieve a record associated with the identity. By analyzing the record and/or the device data 120, the server computer 118 can determine a current network connection for the user device 102 and/or the group device 114; determine if a device group has been created that includes the user device 102, the group device 114, and/or other devices in that device group; geographic locations of devices associated with the records and/or device data 120; manage and/or conduct group communications for devices in the device group with one or more resources 132A-N (hereinafter collectively and/or generically referred to as “resources 132”); update one or more records in the user database 122; and/or perform other operations as illustrated and described herein. Management of communications for the device group will be illustrated and described in more detail below. It should be noted, however, that although the server computer 118 can enable other devices (e.g., the resources 132 themselves) to manage group communications for the devices in a device group in various embodiments, the described example embodiments will include management by the server computer 118 for purposes of simplifying the description of the concepts and technologies disclosed herein. It should be understood that this example embodiment is illustrative, and therefore should not be construed as being limiting in any way.

According to various embodiments, the server computer 118 can determine, based on the device data 120, that the user device 102 is currently connected to a satellite associated with the direct-to-cell satellite network 110. In some embodiments, the server computer 118 may also determine that other devices (e.g., the group device 114) are included in a device group associated with the user device 102 and that the other devices (e.g., the group device 114) does not currently have a reliable network connection (other than through the user device 102 as will be explained in more detail herein). Based on this and/or other determinations, the server computer 118 can retrieve a record for the group device 114 and update the record associated with the group device 114 to indicate that the group device 114 does not have a network connection, that the group device 114 is communicating as part of a device group through the user device 102, and the like. It should be understood that this example embodiment is illustrative, and therefore should not be construed as being limiting in any way.

It can be appreciated that in various embodiments, connectivity provided to devices (e.g., the user device 102) by the direct-to-cell satellite network 110 may be limited in terms of latency, bandwidth, other functionality, and the like. Thus, the server computer 118 can be configured to determine if the user device 102 is connected to the direct-to-cell satellite network 110 for purposes of performing various operations based on the user device 102 and/or devices sharing that network connection being expected to have limited connectivity in these situations. The server computer 118 also can be configured to request prioritization of communications for the user device 102 over the direct-to-satellite connection, in some embodiments, as will be explained in more detail below.

As mentioned above, the resources 132 can be communicated with by one or more devices in the device group such as the user device 102, the group device 114, or the like. According to various embodiments of the concepts and technologies disclosed herein, the resources 132 can include various online resources such as, for example, websites, applications, services, data servers, or the like. According to various embodiments of the concepts and technologies disclosed herein, the user device 102 may be configured to connect to the resources 132 via the direct-to-cell satellite network 110, or to conduct communications with the resources 132 via the direct-to-cell satellite network 110 and the server computer 118. In some embodiments, the devices in the device group (e.g., the group device 114) can be configured to communicate with the resources 132 via the user device 102, the direct-to-cell satellite network 110, and/or the server computer 118; with data being passed between the group device 114 and the user device 102 via a peer-to-peer connection, session, or network (hereinafter referred to as a “peer-to-peer network 126”). It should be understood that this example embodiment is illustrative, and therefore should not be construed as being limiting in any way.

In particular, the user device 102 and the group device 114 can be configured to establish a peer-to-peer network 126 to communicate with one another since the group device 114 may not have any other data connectivity (e.g., network connection) at a particular time (e.g., at the second time T₂ illustrated in FIG. 1A). The peer-to-peer network 126 can be established using various technologies including, but not limited to, Bluetooth technologies, WiFi technologies such as WiFi Direct connections, ad-hoc networks such as Smartphone Ad Hoc Networks (“SPANs”), various mesh network technologies, combinations thereof, or the like. Because the establishment of peer-to-peer networks is generally understood, these and other technologies will not be further described in detail here.

According to various embodiments of the concepts and technologies disclosed herein, as is most clearly shown in FIG. 1B, the group device 114 can exchange, with the user device 102, group device data 128. The group device data 128 can correspond to data communications between the group device 114 and the resource 132, though the actual communication of the data over a network connection can be via the user device 102. It should be noted that the illustrated embodiment is not a “tether” arrangement, where the user device 102 shares the connection with the group device 114. Rather, the user device 102 communicates with the resource 132 on behalf of the group device 114, with the communications being managed by the connection sharing application 108 at the user device 102 and the group device 114 (e.g., labeling data for specific devices, providing data to the resources 132 directly and/or via the server computer 118, obtaining data back from the resources 132 and/or the server computer 118, extracting data for the group device 114, and sending the group device data 128 to the group device 114, and the like).

The user device 102 can be configured, for example via execution of the connection sharing application 108, to exchange group data 130 with the resources 132, with the group data 130 including the group device data 128 and optionally any data generated by the user device 102 for communications with the resources 132. As such, it can be appreciated that the group data 130 can include data for two or more sessions or connections with the resources 132 (e.g., a first session or first connection between the group device 114 and one of the resources 132 and a second session or second connection between the user device 102 (or other device in the device group) and the same one of the resources 132 or a second resource 132). Thus, the user device 102 and the server computer 118 can be configured to combine data for multiple sessions, connections, and/or users of the resources 132 into a single data stream or data file (e.g., the illustrated group data 130) and/or to manage exchange of the data between the endpoints of the sessions, connections, and/or users (e.g., the resources 132 and the devices of the device group). For example, the server computer 118 can be configured to divide the group data 130 into a first instance of resource data 134A for delivery to a first resource 132A and a second instance of resource data 134N for delivery to a second resource 132N. Similarly, the server computer 118 can be configured to receive, from the resources 132, the instances of resource data 134A-N (hereinafter collectively and/or generically referred to as “resource data 134”), to compile the resource data 134 into the group data 130, and to send the group data 130 to the user device 102. It should be understood that this example embodiment is illustrative, and therefore should not be construed as being limiting in any way.

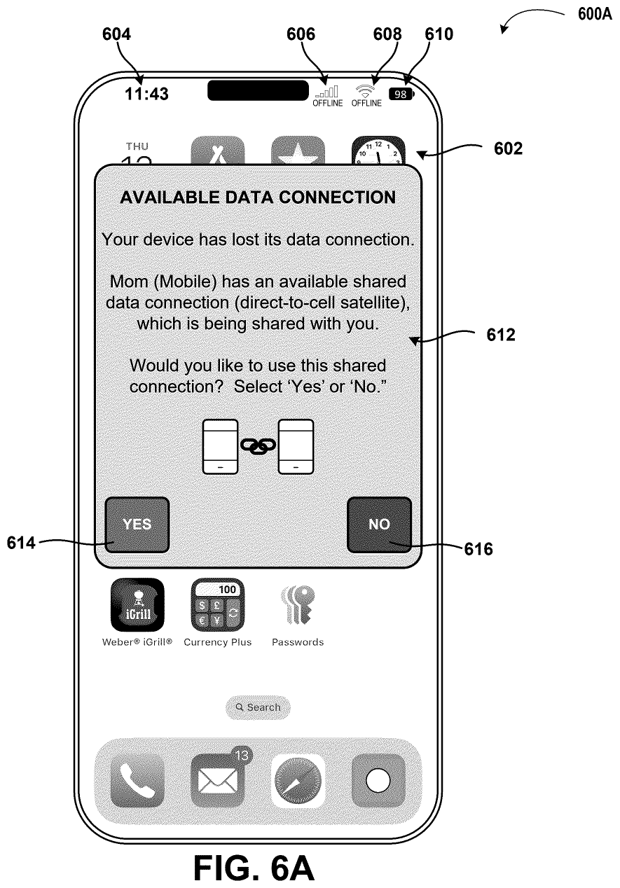

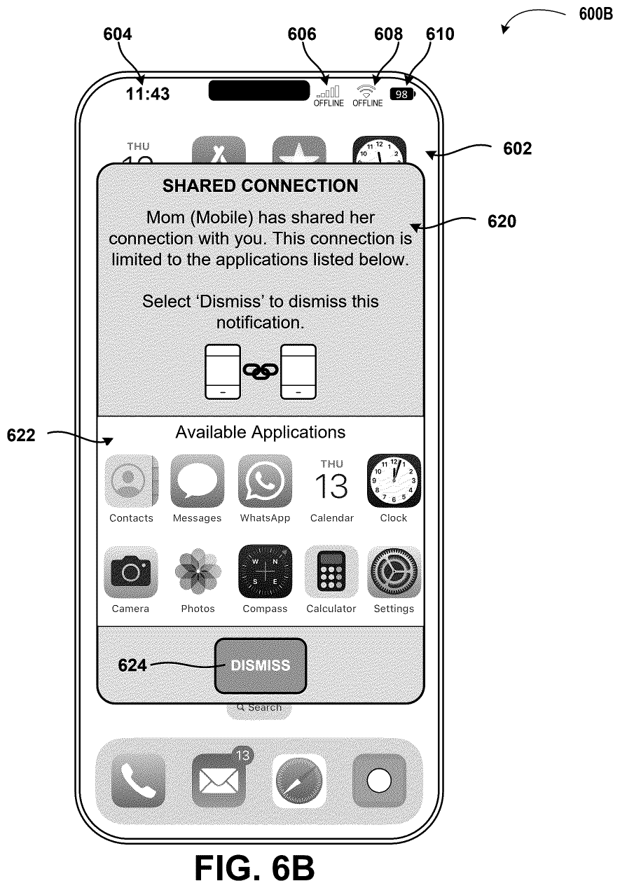

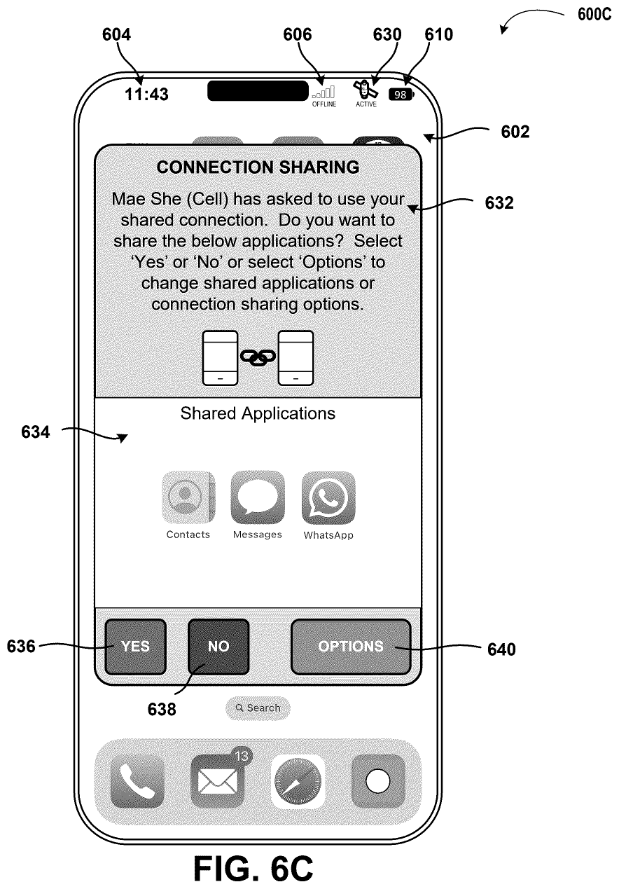

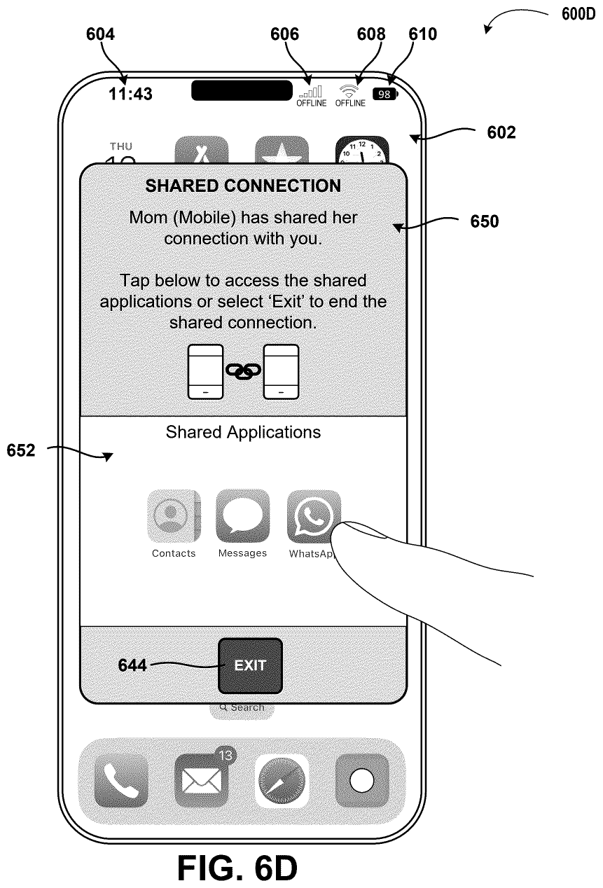

According to various embodiments of the concepts and technologies disclosed herein, the connection sharing application 108 can also be executed by devices of the device group (e.g., the user device 102 and the group device 114) to manage application access by devices in the device group. In particular, because the direct-to-cell satellite network connection provided by the direct-to-cell satellite network 110 may be limited in terms of bandwidth, latency, and the like, the connection sharing application 108 can also limit application usage by devices using a shared connection. For example, if the user device 102 shares its direct-to-cell satellite network connection with the group device 114, the user device 102 may be configured to limit usage of that connection to specific applications such as, for example, text messaging, or the like and/or to restrict the usage of the connection to disallow some applications such as streaming video or audio applications, or the like. The user device 102 can apply these limits by analyzing data included in the group device data 128 and restricting the transmission of the data included in the group device data 128 (e.g., as part of the group data 130) to data for permitted applications. The user device 102 can also be configured to inform the group device 114 as to what applications are allowed, and the group device 114 can be configured to generate updates at a user interface of the group device 114 to communicate these restrictions to the group member. The user device 102 can also provide updates via a user interface at the user device 102. Examples of some example user interfaces that can be generated at the user device 102, the group device 114, and/or other devices in the device group are illustrated and described hereinbelow with reference to FIGS. 6A-6D. It should be understood that this example embodiment is illustrative, and therefore should not be construed as being limiting in any way.

In some embodiments of the concepts and technologies disclosed herein, the user device 102 (or other device managing the device group) can also be configured to enable application sharing. Application sharing within the context of embodiments of the concepts and technologies disclosed herein can include the user device 102 sharing with the group device 114, e.g., via the peer-to-peer network 126, an application that is executing at the user device 102 (and exchanging data with a resource 132 via the direct-to-cell satellite network 110) instead of obtaining and exchanging data on behalf of the group device 114. Thus, for example, the group device 114 may access an application at the user device 102 and interact with the application, with communications generated and/or received by that application occurring at the user device 102 but appearing, to a user of the group device 114, as if the application is being executed at the group device 114. What applications are or will be shared by the user device 102 can be configured by application settings (e.g., settings of the connection sharing application 108), user preferences, or the like.

In some embodiments of the concepts and technologies disclosed herein, the user device 102 (or other device managing the device group) can also be configured to enable application pulling functionality, meaning the user device 102 can pull data from applications executing at the group device 114 by virtue of the group device 114 being included in the device group. Thus, the user device 102 may be configured not only to share applications with the group device 114, but also to pull information from the group device 114 under certain circumstances that can be configured by the user of the user device 102, by application or service settings, and/or by the group member that uses the group device 114. In one contemplated embodiment, an emergency condition may exist for the group member, and the user device 102 can be used to pull biometric and/or medical information from the group device 114 for communicating to the server computer 118 or other entities. For example, the user device 102 can obtain, from the group device 114, biometric readings for the group member, which can be obtained from biometric sensors at the group device 114, and the user device 102 can communicate to the coverage management service 116 or other entity that an emergency condition exists at the group device 114, along with biometric readings, health information, or the like. It should be understood that this example embodiment is illustrative, and therefore should not be construed as being limiting in any way.

The server computer 118 also can be configured, in some embodiments, to determine that traffic associated with the user device 102, the group device 114, and/or other devices in the device group should be prioritized. For example, if the server computer 118 determines that an emergency condition exists (e.g., because the user device 102 may have provided health or biometric information associated with the group device 114), the server computer 118 can determine that traffic associated with the user device 102 should be prioritized (e.g., to increase a speed and/or reliability associated with the direct-to-cell satellite network connection). The server computer 118 can be configured to generate a prioritization command (“command”) 136 and provide the command 136 to the direct-to-cell satellite network 110. The direct-to-cell satellite network 110 can be configured to prioritize traffic associated with the device group (e.g., the user device 102, the group device 114, and the like) based on receiving the command 136 in various embodiments. It should be understood that this example embodiment is illustrative, and therefore should not be construed as being limiting in any way.

In practice, a user device 102 can be connected to a wireless network 112 such as a WiFi network, a cellular network, combinations thereof, or the like. The user device 102 can move out of a coverage area CA_{W} associated with the wireless network 112 at some time. At another time, the user device 102 can move into a satellite coverage area CA_{S} associated with a direct-to-cell satellite network 110. The user device 102 can be configured to communicate via the direct-to-cell satellite network 110. A group device 114 can be in proximity to the user device 102. As used herein, the group device 114 and the user device 102 can be referred to as being “in proximity to” one another if the user device 102 and/or the group device 114 are within direct communication range of one another using a short-range peer-to-peer wireless technology, with the short-range peer-to-peer wireless technology being used to communicate between the user device 102 and the group device 114. Short-range peer-to-peer wireless technologies that can be used in embodiments of the concepts and technologies disclosed herein can include, but are not necessarily limited to, technologies such as WiFi, Bluetooth, NFC, and the like, which can be used to establish a peer-to-peer network between the user device 102 and the group device 114 (and/or other devices that collectively can provide a device group as illustrated and described herein). It should be understood that this example embodiment is illustrative, and therefore should not be construed as being limiting in any way.

It can be appreciated that not all devices may be equipped, enabled, and/or able to access a direct-to-cell satellite network 110 at some time (e.g., the devices may not have the appropriate hardware, cases or power levels may prevent connecting, or the like). Thus, embodiments of the concepts and technologies disclosed herein can include the user device 102 connecting to the direct-to-cell satellite network 110 and being configured to share this connection. In particular, by executing a connection sharing application 108, the user device 102 can share the direct-to-cell satellite network connection with other devices. The user device 102 can query devices in proximity to the user device 102 (e.g., in range as explained herein) and offer to share the direct-to-cell satellite network connection provided by the direct-to-cell satellite network 110. One or more devices may accept the invitation to access the shared direct-to-cell satellite network connection. These communications can include presenting options on user interfaces of the user device 102 and/or the group device 114, and communicating to offer and/or accept sharing of the direct-to-cell satellite network connection. It should be understood that this example embodiment is illustrative, and therefore should not be construed as being limiting in any way.

The user device 102 can be configured to share the direct-to-cell satellite network connection with other devices in the device group (e.g., the group device 114) in several manners. In some embodiments, the user device 102 can receive group device data 128 from the group device 114 via the peer-to-peer network 126. The group device data 128 can include application data from the group device 114 that is to be provided to a resource 132 (e.g., a remote application server, website, or the like). The resource 132 can be remote from the peer-to-peer network 126, the user device 102, and the group device 114, but accessible to the user device 102 via the direct-to-cell satellite network 110 and/or other connections (e.g., via the network 104, the server computer 118, and the like). The user device 102 can create group data 130, which can include the group device data 128 and optionally data from other devices in the device group. The user device 102 can transmit the group data 130 to the resource 132 (or can direct other devices to transmit the group data 130 to the resource 132 via one or more other devices and/or networks such as the server computer 118). It should be understood that this example embodiment is illustrative, and therefore should not be construed as being limiting in any way.

The server computer 118 or other device can be configured to obtain the group data 130, extract one or more instances of resource data 134 for providing to one or more of the resources 132, and provide the resource data 134 to the resources 132. The resources 132 can process the resource data 134 as if received from the group device 114 and respond with another instance of the resource data 134. The server computer 118 or other device can create another instance of the group data 130 and provide the group data 130 back to the user device 102. The user device 102 can be configured to extract, from the group data 130, another instance of group device data 128 and provide the other instance of the group device data 128 to the group device 114 via the peer-to-peer network 126. It should be understood that this example embodiment is illustrative, and therefore should not be construed as being limiting in any way. In some embodiments, the user device 102 can also be configured to obtain, from devices in the device group such as the group device 114, biometric data that can be obtained by biometric sensors at the group device 114. Other information can be obtained by the user device 102 from the group device 114 such as, for example, contacts, health information, or the like, which the group device 114 may have selected for sharing via the connection sharing application 108 installed at the group device 114. The user device 102 can provide the biometric data to the server computer 118, which can be configured to perform operations to prioritize group traffic based on the biometric data in some instances. It should be understood that this example embodiment is illustrative, and therefore should not be construed as being limiting in any way.

FIGS. 1A-1B illustrate one user device 102, one network 104, one direct-to-cell satellite network 110 having one satellite, one wireless network 112, one server computer 118, one group device 114, one data store 124, two resources 132, and one peer-to-peer network 126. It should be understood, however, that various implementations of the operating environment 100 can include one or more than one user device 102; one or more than one network 104; one or more than one direct-to-cell satellite network 110 (one or more of which may have one or more than one satellite); one or more than one wireless network 112; one or more than one server computer 118; zero, one, or more than one group device 114; zero, one, or more than one data store 124; zero, one, two, or more than two resources 132; and one or more than one peer-to-peer network 126. As such, the illustrated embodiment should be understood as being illustrative, and should not be construed as being limiting in any way.

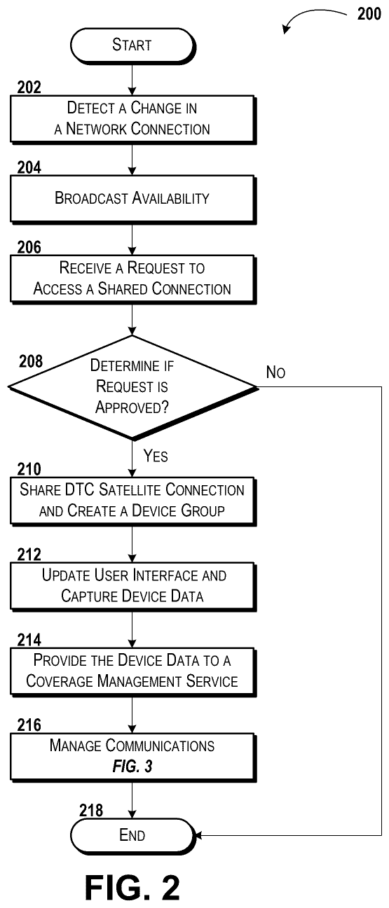

Turning now to FIG. 2, aspects of a method 200 for creating and using a device group during direct-to-cell satellite coverage will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 and/or the server computer 118 to perform one or more operations and/or causing the processor to direct other components of the computing system or device to perform one or more of the operations.

For purposes of illustrating and describing the concepts of the present disclosure, the method 200 is described herein as being performed by the user device 102 via execution of one or more software modules such as, for example, the connection sharing application 108. It should be understood that additional and/or alternative devices and/or network nodes can provide the functionality described herein via execution of one or more modules, applications, and/or other software including, but not limited to, the connection sharing application 108. For example, the group device 114 can perform substantially similar (or even identical) operations if the group device 114 shares a network connection of the group device 114 with the user device 102 (instead of the illustrated arrangement). Thus, the illustrated embodiments are illustrative, and should not be viewed as being limiting in any way.

The method 200 begins at operation 202. At operation 202, the user device 102 can detect a change in a network connection of the user device 102. In operation 202, for example, the user device 102 can detect that the user device 102 has connected to a network connection other than a previous network connection, has connected to a network connection in addition to a previous network connection to which the user device 102 was connected, disconnected from one or more network connections to which the user device 102 was connected, or the like. In some embodiments, operation 202 can include the user device 102 connecting to a network connection associated with a direct-to-cell satellite network 110 as a primary network connection, as a backup network connection, or the like; the user device 102 connecting to a network connection associated with the wireless network 112 as a primary network connection, backup network connection, or the like; the user device 102 disconnecting from one or more network connections; combinations thereof; or the like.

Thus, operation 202 can include the user device 102 detecting any sort of connection to, or disconnection from, a network connection. In various embodiments, the network connection change detected in operation 202 can correspond to the user device 102 connecting to a network connection that can have limited connectivity such as a connection with the direct-to-cell satellite network 110. As used herein, “limited connectivity” can be used to describe a network connection that can be, for example, limited in terms of latency (e.g., have a high latency or lag such as a latency over one hundred milliseconds, two hundred milliseconds, five hundred milliseconds, one second, or the like) and/or bandwidth (e.g., having a bandwidth limited to less than one megabit per second, less than five hundred kilobits per second, less than one hundred kilobits per second, or the like), and the like, which may frequently be the case for direct-to-cell satellite network connections.

It can be appreciated that limits on bandwidth and/or latency (e.g., limits as to what is defined in embodiments of the concepts and technologies disclosed herein as “high latency” and/or “low bandwidth” for purposes of defining a connection as “limited”) can be defined by settings, configurations, user preferences, and the like. In any event, operation 202 can also include the user device 102 determining that a limited-connectivity connection is a primary connection and that this connection exists for the user device 102 with or without any backup network connection that has improved performance relative to the network connection with the direct-to-cell satellite network 110, for example, a cellular connection, a WiFi connection, or the like. It should be understood that this example embodiment is illustrative, and therefore should not be construed as being limiting in any way. As used in the claims, the phrase “limited-connectivity” can refer to a network connection to which the user device 102 is connected, where the network connection has a high latency or lag and/or low bandwidth, and where the user device 102 does not have a backup network connection available.

From operation 202, the method 200 can proceed to operation 204. At operation 204, the user device 102 can broadcast availability of the direct-to-cell satellite network connection determined to exist in operation 202. It can be appreciated that the user device 102 can be configured (e.g., via execution of the connection sharing application 108) to share some network connections such as, for example, a direct-to-cell satellite network connection. The user device 102 also can be configured to broadcast the availability of the direct-to-cell satellite network connection to devices in its proximity as those devices may not be equipped to communicate with a direct-to-cell satellite network 110. It should be understood that this example embodiment is illustrative, and therefore should not be construed as being limiting in any way.

In the example embodiment shown in FIGS. 1A-1B, the group device 114 is not enabled and/or equipped for communications via the direct-to-cell satellite network 110, but may be equipped, e.g., via executing the connection sharing application 108, to detect a broadcast from the user device 102 such as that generated in operation 204. According to various embodiments of the concepts and technologies disclosed herein, the broadcast generated by the user device 102 in operation 204 can be sent via a wireless communication via WiFi, Bluetooth, or the like and received by any devices within communication range of the user device 102, as is generally understood. It should be understood that this example embodiment is illustrative, and therefore should not be construed as being limiting in any way.

From operation 204, the method 200 can proceed to operation 206. At operation 206, the user device 102 can receive a request to access a shared connection, specifically a shared direct-to-cell satellite network connection. For example, operation 206 can correspond to one or more devices responding to the broadcast message sent by the user device 102 in operation 204. In the example embodiment illustrated in FIGS. 1A-1B, operation 206 can correspond to the group device 114 responding to the user device 102 that the group device 114 requests to use the shared direct-to-cell satellite network connection of the user device 102. It should be understood that this example embodiment is illustrative, and therefore should not be construed as being limiting in any way.

From operation 206, the method 200 can proceed to operation 208. At operation 208, the user device 102 can determine if the request to access the shared connection (received in operation 206) is approved. According to various embodiments of the concepts and technologies disclosed herein, the user device 102 (or other device that executes the connection sharing application 108) can maintain a list of contacts or devices that are authorized to share a network connection of the user device 102. For example, the group device 114 may be identified as a device that is authorized to use the connection shared by the user device 102 in some embodiments. It should be understood that this example embodiment is illustrative, and therefore should not be construed as being limiting in any way.

According to some embodiments, the user device 102 (or other device that executes the connection sharing application 108) can be configured to present, at the user device 102, a user interface that obtains input from the user as to whether the network connection of the user device 102 should be shared with others in proximity to the user device 102. Thus, for example, devices or people co-located at some time may create a device group without previously knowing one another and/or setting up a device group. In one example embodiment, the user device 102 can present a user interface via which a user can select to share the network connection, not to share the connection, or the like. Thus, operation 208 can include presenting a user interface, obtaining input via the user interface, and determining, based on the input, if the sharing is to be allowed. It should be understood that this example embodiment is illustrative, and therefore should not be construed as being limiting in any way.

If the user device 102 determines, in operation 208, that the request to access the shared direct-to-cell satellite network connection has been approved, the method 200 can proceed to operation 210. At operation 210, the user device 102 can share the direct-to-cell satellite network connection and create a device group. Operation 210 can include the user device 102 creating a peer-to-peer network 126 (or other peer-to-peer connection) with the one or more devices being added to the device group such as the group device 114. It should be understood that this example embodiment is illustrative, and therefore should not be construed as being limiting in any way. The user device 102 can create the device group by enabling access (as explained below with reference to operation 216) to the direct-to-cell satellite network connection to one or more other devices as allowed in operation 208, for example, via the peer-to-peer network 126. It should be understood that this example embodiment is illustrative, and therefore should not be construed as being limiting in any way.

From operation 210, the method 200 can proceed to operation 212. At operation 212, the user device 102 can update a user interface and capture (and/or create) the device data 120. In particular, operation 204 can correspond to the user device 102 updating a user interface at the user device 102 (e.g., to show the new or changed network connection(s) detected in operation 202, to provide information about the device group, to select what applications to share with devices in the device group, combinations thereof, or the like) and capturing the components of the device data 120 illustrated and described herein including, but not limited to, identity data that can identify the user device 102 and/or a user thereof, connection data that can identify the current network connection(s) and/or status thereof for the user device 102, group data for devices included in the device group (e.g., the group device 114), biometric data that can include biometric sensor readings captured via the biometric sensors at the group device 114 (e.g., for the group member), and/or other data (e.g., identifying one or more other devices in proximity to the user device 102) that can be included in the device data 120 as illustrated and described herein. Thus, operation 212 can include the user device 102 generating the device data 120 illustrated and described herein (e.g., due to the detected change in the network connection). It should be understood that this example embodiment is illustrative, and therefore should not be construed as being limiting in any way.

From operation 212, the method 200 can proceed to operation 214. At operation 214, the user device 102 can provide the device data 120 generated in operation 212 to the coverage management service 116 (and/or to the server computer 118 that hosts and/or executes the coverage management service 116). In various embodiments of the concepts and technologies disclosed herein, operation 214 can correspond to the user device 102 transmitting the device data 120 to the server computer 118 via the direct-to-cell satellite network 110. It should be understood that this example embodiment is illustrative, and therefore should not be construed as being limiting in any way.

From operation 214, the method 200 can proceed to operation 216. At operation 216, the user device 102 can manage communications between devices in the device group and one or more resources 132. It can be appreciated from the embodiments illustrated and described herein that the managing the communications for the device group can include managing communications, over the direct-to-cell satellite network connection, between one or more devices in the device group and one or more resources 132. Thus, operation 216 can include, in various embodiments, the user device 102 managing communications on behalf of members of the device group (e.g., the group device 114) to exchange data between the group device 114 and a resource 132. As noted above, the user device 102 may not share the direct-to-cell satellite network connection to enable unlimited access to the direct-to-cell satellite network connection due to the limited connectivity that may be enabled by the direct-to-cell satellite network connection.

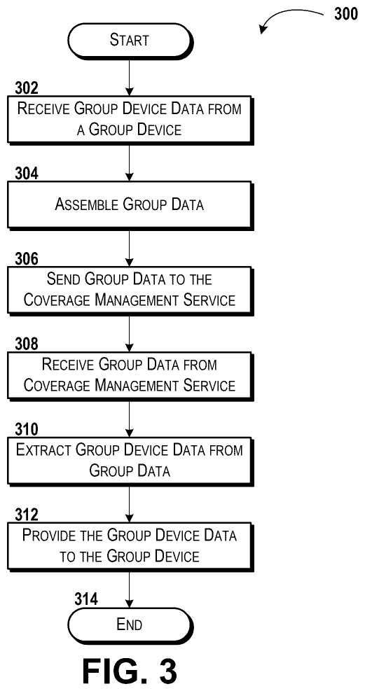

Thus, operation 216 can include the user device 102 managing the communications by determining how the direct-to-cell satellite network connection will be shared, for example by the user device 102 sharing applications with the devices in the device group (e.g., the group device 114), by the user device 102 obtaining application data from the devices in the device group for relaying to other entities such as the resources 132, combinations thereof, or the like. Additional details of enabling communications via the shared direct-to-cell satellite network connection are illustrated and described below with reference to FIG. 3. It should be understood that this example embodiment is illustrative, and therefore should not be construed as being limiting in any way.

From operation 216, the method 200 can proceed to operation 218. The method 200 can also proceed to operation 218 from operation 208 if the user device 102 determines, in operation 208, that the request to access the shared connection has not been approved. The method 200 can end at operation 218.

Turning now to FIG. 3, aspects of a method 300 for exchanging data within a device group during direct-to-cell satellite coverage will be described in detail, according to an illustrative embodiment. For purposes of illustrating and describing the concepts of the present disclosure, the method 300 is described herein as being performed by the user device 102 via execution of one or more software modules such as, for example, the connection sharing application 108. It should be understood that additional and/or alternative devices and/or network nodes can provide the functionality described herein via execution of one or more modules, applications, and/or other software including, but not limited to, the connection sharing application 108. For example, the group device 114 can perform substantially similar (or even identical) operations if the group device 114 shares a network connection of the group device 114 with the user device 102 (instead of the illustrated arrangement). Thus, the illustrated embodiments are illustrative, and should not be viewed as being limiting in any way.

Similarly, the method 300 will be explained using an example embodiment in which the group device 114 and the user device 102 are in a device group, and where the user device 102 is sharing a direct-to-cell satellite network connection with the group device 114 (where the user device 102 is enabled/equipped to access the direct-to-cell satellite network 110 and the group device 114 is not enabled/equipped to access the direct-to-cell satellite network 110). It should be understood, however, that in some embodiments of the method 300, the group device 114 and the user device 102 can be in a device group, and the user group device 114 can share a direct-to-cell satellite network connection with the user device 102 (where the user device 102 may not be enabled/equipped to access the direct-to-cell satellite network 110 and the group device 114 may be enabled/equipped to access the direct-to-cell satellite network 110). As such, the illustrated embodiment is illustrative and should not be construed as being limiting in any way.

The method 300 begins at operation 302. At operation 302, the user device 102 can receive group device data 128 from the group device 114. It can be appreciated that before operation 302 occurs, the user device 102 can have previously a) shared specific applications with the group device 114 (e.g., applications executed by the user device 102 that can be shared with the group device 114), b) indicated to the group device 114 what application data can be transmitted via the shared network connection (e.g., applications executed at the group device 114), or the like. In any event, the group device data 128 can correspond to data associated with an application session or the like between the group device 114 and a resource 132, where the group device data 128 can correspond to application data generated at the group device 114 and intended for transfer to the resource 132. It should be understood that this example embodiment is illustrative, and therefore should not be construed as being limiting in any way.

From operation 302, the method 300 can proceed to operation 304. At operation 304, the user device 102 can assemble the group data 130. In operation 304, the user device 102 can create group data 130, which can correspond to data for one or more data sessions between devices in the device group and one or more resources 132. Thus, operation 304 can correspond to the user device 102 assembling data for multiple data sessions into a data file or data stream. If more than one data session is occurring via the shared connection between the user device 102 and the direct-to-cell satellite network 110, operation 304 can include the user device 102 labeling the data (e.g., in headers or the like) to designate an origin of the data (e.g., the group device 114 or the user device 102) and a destination for the data (e.g., a first of the resources 132 or a second of the resources 132). It should be understood that this example embodiment is illustrative, and therefore should not be construed as being limiting in any way.

From operation 304, the method 300 can proceed to operation 306. At operation 306, the user device 102 can send the group data 130 to the coverage management service 116. As explained herein, the coverage management service 116 can be configured to manage group communications with one or more of the resources 132 in some embodiments, though this is not necessarily the case. Thus, it can be appreciated that the user device 102 can be configured in some embodiments to send the group data 130 to other devices (e.g., controllers, nodes, or the like) instead of, or in addition to, the coverage management service 116. It should be understood that this example embodiment is illustrative, and therefore should not be construed as being limiting in any way.

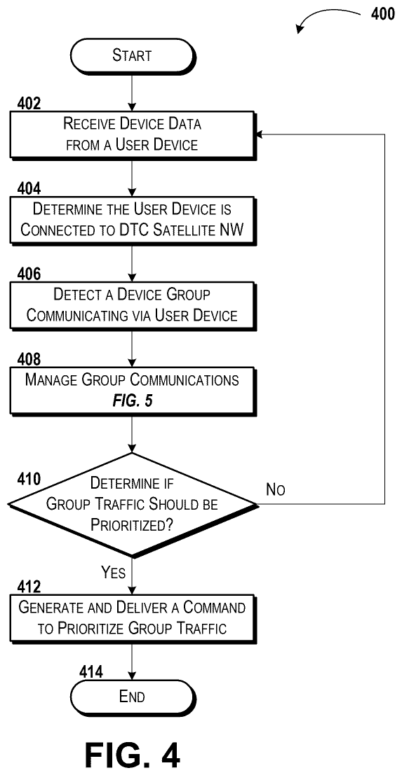

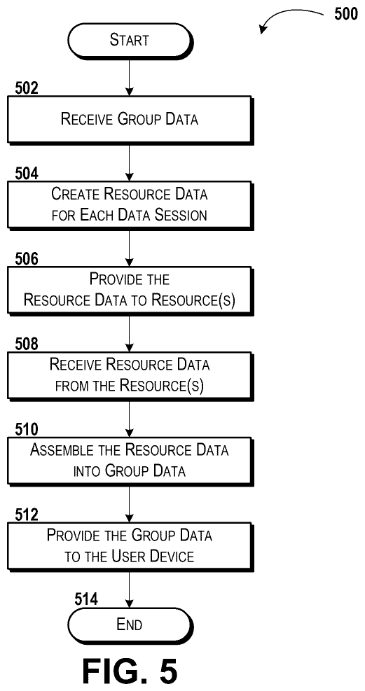

Although not illustrated in FIG. 3, it can be appreciated that the coverage management service 116 can be configured to manage data for the shared network connection. Thus, the coverage management service 116 can receive the group data 130, send portions of the group data 130 (e.g., one or more instances of resource data 134) to the appropriate resources 132, receive one or more instances of resource data 134 from the resources 132, and create another instance of group data 130 for sending back to the user device 102. These and other functions of the coverage management service 116 and/or the server computer 118 that hosts and/or executes the coverage management service 116 will be illustrated and described hereinbelow with reference to FIGS. 4-5. It should be understood that this example embodiment is illustrative, and therefore should not be construed as being limiting in any way.

From operation 306, the method 300 can proceed to operation 308. At operation 308, the user device 102 can receive group data 130 from the coverage management service 116 and/or other devices as illustrated and described herein. From operation 308, the method 300 can proceed to operation 310. At operation 310, the user device 102 can extract one or more instances of group device data 128 from the group data 130 received in operation 308. It can be appreciated that the group data 130 can include, in some embodiments, data associated with one or more data sessions between devices in the device group and the resources 132, and therefore the user device 102 can be configured to identify and extract from the group data 130 the one or more instances of group device data 128. It should be understood that this example embodiment is illustrative, and therefore should not be construed as being limiting in any way.

From operation 310, the method 300 can proceed to operation 312. At operation 312, the user device 102 can provide the one or more instances of the group device data 128 to the appropriate devices in the device group. For example, if the user device 102 and the group device 114 are both exchanging data with resources 132, operation 310 can correspond to the user device 102 extracting, from the group data 130, a first instance of group device data 128 for delivery to the group device 114 and operation 312 can correspond to the user device 102 providing the first instance of group device data 128 to the group device 114 via a peer-to-peer network 126 established between the user device 102 and the group device 114. Of course, the user device 102 can retain other portions of the group data 130 for itself (e.g., to process as part of its data session with one of the resources 132). It should be understood that this example embodiment is illustrative, and therefore should not be construed as being limiting in any way.

From operation 312, the method 300 can proceed to operation 314. The method 300 can end at operation 314.

Turning now to FIG. 4, aspects of a method 400 for detecting a device group during direct-to-cell satellite coverage will be described in detail, according to an illustrative embodiment. For purposes of illustrating and describing the concepts of the present disclosure, the method 400 is described herein as being performed by the server computer 118 via execution of one or more software modules such as, for example, the coverage management service 116. It should be understood that additional and/or alternative devices and/or network nodes can provide the functionality described herein via execution of one or more modules, applications, and/or other software including, but not limited to, the coverage management service 116. Thus, the illustrated embodiments are illustrative, and should not be viewed as being limiting in any way.

The method 400 begins at operation 402. At operation 402, the server computer 118 can receive device data 120 from a user device 102 (or other device that generated the device data 120 such as the group device 114). According to various embodiments of the concepts and technologies disclosed herein, the user device 102 can be configured to send the device data 120 to the server computer 118 when a network connection change is detected at the user device 102, at regular and/or irregular time intervals, on request from the server computer 118 and/or other devices or entities, when the user device 102 detects certain network connection changes (e.g., connection to or disconnection from the direct-to-cell satellite network 110, when a device group is created, combinations thereof, or the like), combinations thereof, or the like.

In some embodiments, the user device 102 can be configured to create and send the device data 120 to the server computer 118 under limited circumstances. In particular, the user device 102 can be configured, in some embodiments, to send the device data 120 to the server computer 118 only when the user device 102 detects the establishment of a connection with a direct-to-cell satellite network 110 with limited or no backup network connection, and when the user device 102 determines that a device group has been created to use the direct-to-cell satellite network connection that is to be shared by the user device 102. Because the device data 120 can be provided to the server computer 118 in additional and/or alternative circumstances, it should be understood that these example embodiments are illustrative, and therefore should not be construed as being limiting in any way.

From operation 402, the method 400 can proceed to operation 404. At operation 404, the server computer 118 can determine that the user device 102 is connected to a direct-to-cell satellite network 110 (and/or a network connection thereto). In particular, the server computer 118 can determine, in operation 404 a network status of the user device 102 and detect that a network connection of the user device 102 corresponds to a connection to a satellite associated with a direct-to-cell satellite network 110. In operation 404, for example, the server computer 118 can analyze the device data 120 to determine what network connections exist for the user device 102 at a current time, and as explained herein the device data 120 can indicate a current network connection of the user device 102. Thus, based on analysis of the device data 120, the server computer 118 can determine the current network connection of the user device 102. In some contemplated example embodiments of the concepts and technologies disclosed herein, for example, the server computer 118 may determine in operation 404 that the user device 102 is currently connected to a direct-to-cell satellite network 110 with no backup network connection or a direct-to-cell satellite network 110 with a limited backup connection. In either event, the server computer 118 may determine that the user device 102 currently has a network connection with limited connectivity. It should be understood that this example embodiment is illustrative, and therefore should not be construed as being limiting in any way.

From operation 404, the method 400 can proceed to operation 406. At operation 406, the server computer 118 can detect a device group communicating via the user device 102. As explained herein, the server computer 118 can detect the device group by accessing the record associated with the user device 102 and determining, based on the group information included therein, that a device group has been created and/or members of that device group include the user device 102. As explained herein, the records for one or more devices and/or users (e.g., as included in the user database 122) can include an indication of a device group to which the associated devices and/or users belong. Thus, operation 406 can include, in the example embodiment illustrated in FIGS. 1A-1B, the server computer 118 determining that the group device 114 and the user device 102 are communicating in a device group (e.g., using the shared direct-to-cell satellite network connection of the user device 102). It should be understood that this example embodiment is illustrative, and therefore should not be construed as being limiting in any way.

From operation 406, the method 400 can proceed to operation 408. At operation 408, the server computer 118 can manage group communications with the user device 102. According to various embodiments of the concepts and technologies disclosed herein, the server computer 118 can manage the group communications by obtaining, from the user device 102, group data 130; analyzing the group data 130 to identify data associated with one or more data sessions (and/or one or more devices of the device group such as the group device 114 and the user device 102); creating and sending, to one or more of the resources 132, one or more instances of resource data 134; receiving from the one or more resources 132 one or more instances of resource data 134 (that is responsive to the resource data 134 provided to the resources 132); assembling the resource data 134 into another instance of group data 130; and providing the group data 130 back to the user device 102. Additional details of enabling communications via the shared direct-to-cell satellite network connection are illustrated and described below with reference to FIG. 5. It should be understood that this example embodiment is illustrative, and therefore should not be construed as being limiting in any way.

From operation 408, the method 400 can proceed to operation 410. At operation 410, the server computer 118 can determine if group traffic should be prioritized. It can be appreciated that operation 410 can be performed at any time (e.g., before operation 408 and/or at any other time), and the illustrated embodiment is illustrative and should not be construed as being limiting in any way. The server computer 118 can determine that the group traffic should be prioritized, for example, by detecting an emergency condition at a device of the device group. For example, the server computer 118 may determine that group traffic should be prioritized based on biometric readings provided with the device data 120 (e.g., pulled by the user device 102 from the group device 114 in an emergency condition, or the like). In other embodiments, a user device 102 may explicitly indicate that an emergency condition exists, and the server computer 118 can determine that the group traffic should be prioritized. It should be understood that this example embodiment is illustrative, and therefore should not be construed as being limiting in any way.

If the server computer 118 determines in operation 410 that group traffic should not be prioritized, the method 400 can return to operation 402. It should be understood that operations 402-410 can be repeated until the server computer 118 determines in any iteration of operation 410 that group traffic should be prioritized. If the server computer 118 determines in any iteration of operation 410 that the group traffic should be prioritized, the method 400 can proceed to operation 412.

At operation 412, the server computer 118 can generate a command 136. The command 136 can indicate that the group traffic (e.g., the transfer of the group data 130 and/or other communications associated with members of the device group such as the user device 102 and the group device 114) should be prioritized by the direct-to-cell satellite network 110. Thus, while the direct-to-cell satellite network connection provided by the direct-to-cell satellite network 110 may be defined herein as a “limited-connectivity” connection (e.g., having a high latency or lag and/or a low bandwidth), prioritization of traffic associated with the device group can result in the direct-to-cell satellite network 110 providing improved performance by increasing the priority for traffic associated with the group (relative to unprioritized traffic). Thus, the direct-to-cell satellite network 110 may respond to any request associated with a prioritized device before any other pending requests (thereby taking the requests out of order, or the like; reducing latency; and/or otherwise prioritizing communications associated with the device group). It should be understood that this example embodiment is illustrative, and therefore should not be construed as being limiting in any way.

From operation 412, the method 400 can proceed to operation 414. The method 400 can end at operation 414.

Turning now to FIG. 5, aspects of a method 500 for providing data to devices of a device group during direct-to-cell satellite coverage will be described in detail, according to an illustrative embodiment. For purposes of illustrating and describing the concepts of the present disclosure, the method 500 is described herein as being performed by the server computer 118 via execution of one or more software modules such as, for example, the coverage management service 116. It should be understood that additional and/or alternative devices and/or network nodes can provide the functionality described herein via execution of one or more modules, applications, and/or other software including, but not limited to, the coverage management service 116. Thus, the illustrated embodiments are illustrative, and should not be viewed as being limiting in any way.

The method 500 begins at operation 502. At operation 502, the server computer 118 can receive group data 130 from the user device 102 (or other device that is managing the communications associated with the device group). The group data 130 can correspond to data associated with one or more application sessions or the like for one or more devices in the device group (e.g., the user device 102, the group device 114, and/or other devices) and one or more resources 132, where the group data 130 can correspond to application data generated at the group device 114 and/or the user device 102 and intended for transfer to one or more of the resources 132. It should be understood that this example embodiment is illustrative, and therefore should not be construed as being limiting in any way.

From operation 502, the method 500 can proceed to operation 504. At operation 504, the server computer 118 can create, from the group data 130 obtained in operation 502, resource data 134 for each data session (represented by data included in the group data 130). In operation 504, the server computer 118 can analyze the group data 130 and identify data for one or more data sessions (e.g., by analyzing headers associated with the data, destination addresses for the data, sources listed for the data, combinations thereof, or the like). The server computer 118 can identify these one or more data sessions occurring via the shared connection between the user device 102 and the direct-to-cell satellite network 110 and separate the data based on the associated data session and/or a destination (e.g., a particular resource 132). This data can then be used to create resource data 134 (e.g. a data file or data stream) to be provided to a particular resource 132 associated with the data session. It should be understood that this example embodiment is illustrative, and therefore should not be construed as being limiting in any way.

From operation 504, the method 500 can proceed to operation 506. At operation 506, the user device 102 can send the instance(s) of resource data 134 to the associated resource(s) 132. The resources 132 can be identified by destination information included in the data (e.g., headers of packets thereof, or the like), and the server computer 118 can provide the resource data 134 to the appropriate recipient (e.g., resource 132). It should be understood that this example embodiment is illustrative, and therefore should not be construed as being limiting in any way. It can be appreciated that the resources 132 can be configured to receive the resource data 134, perform various operations on that resource data 134, and create another instance of resource data 134 (that is responsive to the resource data 134 generated by the server computer 118) for sending back to the user device 102. It should be understood that this example embodiment is illustrative, and therefore should not be construed as being limiting in any way.

From operation 506, the method 500 can proceed to operation 508. At operation 508, the server computer 118 can receive one or more instances of the resource data 134 from the one or more resources 132. From operation 508, the method 500 can proceed to operation 510. At operation 510, the server computer 118 can assemble the one or more instances of resource data 134 received in operation 508 to create another instance of group data 130 for providing back to the user device 102. It can be appreciated that the group data 130 can include, in some embodiments, data associated with one or more data sessions between devices in the device group and the resources 132. It should be understood that this example embodiment is illustrative, and therefore should not be construed as being limiting in any way.

From operation 510, the method 500 can proceed to operation 512. At operation 512, the server computer 118 can provide the group data 130 assembled in operation 510 to the user device 102. It can be appreciated that the server computer 118 can provide the group data 130 to the user device 102 via the direct-to-cell satellite network 110. It should be understood that this example embodiment is illustrative, and therefore should not be construed as being limiting in any way.

From operation 512, the method 500 can proceed to operation 514. The method 500 can end at operation 514.

FIGS. 6A-6D are user interface (“UI”) diagrams showing aspects of UIs for using and/or interacting with the connection sharing application 108 and/or the coverage management service 116, according to some illustrative embodiments. In accordance with the example embodiment shown in FIGS. 1A-1B, FIGS. 6A, 6B, and 6D will be described as being presented at the group device 114, and FIG. 6C will be described as being presented at the user device 102. It should be understood that this example is illustrative and should not be construed as being limiting in any way.

FIG. 6A shows an illustrative screen display 600A. According to some embodiments of the concepts and technologies described herein, the screen display 600A can be generated by the group device 114 via interactions with the connection sharing application 108 and/or the coverage management service 116. It should be appreciated that the UI diagram illustrated in FIG. 6A is illustrative of one contemplated example of the UIs that can be generated and/or displayed in accordance with the concepts and technologies disclosed herein, and therefore should not be construed as being limiting in any way. According to various embodiments, the screen display 600A can be presented, for example, when the group device 114 has lost a network connection, and the user device 102 has connected to a limited-connectivity network connection associated with a direct-to-cell satellite network 110 and has offered to share the direct-to-cell satellite network connection with the group device 114. It should be understood that this example embodiment is illustrative, and therefore should not be construed as being limiting in any way.

In the example screen display 600A shown in FIG. 6A, the group device 114 is illustrated as displaying a home screen 602. It should be understood that this example embodiment is illustrative, and therefore should not be construed as being limiting in any way. Because one or more elements of the screen display 600A illustrated in FIG. 6A can be displayed at additional and/or alternative times (e.g., when the group device 114 is locked), and because one or more elements of the screen display 600A may or may not be included in all embodiments, it should be understood that the illustrated example embodiment is illustrative and therefore should not be construed as being limiting in any way.

As is generally understood and as is illustrated in FIG. 6A, the home screen 602 can include various types of data and/or information such as time and/or date information 604, which can display a current time and/or date; carrier information (not illustrated in FIG. 6A), which can be included to indicate a carrier associated with a primary network connection and/or network to which the group device 114 is connected at the time; signal strength information 606 for the primary network connection, which can indicate a strength of a signal associated with the primary network to which the user device 102 is connected (or not connected) at the time; a WiFi signal indicator 608, which can indicate in some instances that a WiFi connection is available, active, and optionally an associated signal strength of the WiFi signal; battery charge information 610; other information; combinations thereof; or the like.

As shown in FIG. 6A, a status of one or more networks can be displayed on the home screen 602 and/or elsewhere. In the illustrated embodiment, a status of “offline” is displayed under the signal strength information 606, thereby indicating that the primary network connection such as a cellular network connection to a terrestrial cellular network is not active at the current time; and a status of “offline” is also displayed under the WiFi signal indicator 608, thereby indicating that a WiFi connection is also unavailable and/or inactive for the group device 114. Thus, in the illustrated embodiment, the group device 114 can currently be operating without any network connection. It should be understood that this example embodiment is illustrative, and therefore should not be construed as being limiting in any way.

According to various embodiments of the concepts and technologies disclosed herein, the screen display 600A also can include a shared network connection availability window 612. The shared network connection availability window 612 can be provided in various conditions illustrated and described herein such as, for example, to inform a user of the group device 114 (e.g., the group member) that the group device 114 does not have any network connection, but that the user device 102 is offering to share a direct-to-cell satellite network connection. In the embodiment shown in FIG. 6A, the shared network connection availability window 612 is illustrated as indicating that the group device 114 has lost its data connection, that the user device 102 has connected to a limited connectivity direct-to-cell satellite network connection, and that user device 102 has made the limited connectivity direct-to-cell satellite network connection available to the group device 114. The shared network connection availability window 612 can also include a prompt, for the group member, if the group device 114 should use the shared connection. It should be understood that this example embodiment is illustrative, and therefore should not be construed as being limiting in any way.

The shared network connection availability window 612 can also include a UI control 614 for selecting a “yes” option and a UI control 616 for selecting a “no” option. In the embodiment shown in FIG. 6A, selection of the UI control 614 can cause the group device 114 to inform the user device 102 that the group device 114 wants to use the shared direct-to-cell satellite network connection. Thus, it can be appreciated that selection of the UI control 614 can cause the group device 114 to create and/or join a peer-to-peer network 126 between the group device 114 and the user device 102. Because additional and/or alternative actions can be taken by the group device 114 in response to detecting selection of the UI control 614, it should be understood that this example embodiment is illustrative, and therefore should not be construed as being limiting in any way.

In the illustrated embodiment, selection of the UI control 616 can cause the group device 114 to inform the user device 102 that the group device 114 does not wish to use the shared direct-to-cell satellite network connection. Thus, selection of the UI control 616 can cause the group device 114 to take no action. It can be appreciated that the group device 114 can periodically attempt to re-establish a network connection with the wireless network 112 (e.g., via WiFi, cellular, or the like). It should be understood that this example embodiment is illustrative, and therefore should not be construed as being limiting in any way. Because the illustrated embodiment of the screen display 600A is illustrative, and because the screen display 600A can include additional and/or alternative information, it should be understood that the embodiment of FIG. 6A is illustrative, and therefore should not be construed as being limiting in any way.

FIG. 6B shows an illustrative screen display 600B. According to some embodiments of the concepts and technologies described herein, the screen display 600B can be generated by a device such as the group device 114 via interactions with the coverage management service 116 and/or communications received from the user device 102 (e.g., a peer-to-peer communication querying the group device 114 as to whether the group device 114 will access a shared direct-to-cell satellite network connection shared by the user device 102). Because the screen display 600B can be displayed at the group device 114 and/or other devices at additional and/or alternative times, it should be understood that this example embodiment is illustrative, and therefore should not be construed as being limiting in any way.

In the example screen display 600B shown in FIG. 6B, the group device 114 is illustrated as displaying a home screen 602. Because one or more elements of the screen display 600B illustrated in FIG. 6B can be displayed at additional and/or alternative times (e.g., when the group device 114 is locked), and because one or more elements of the screen display 600B may or may not be included in all embodiments, it should be understood that the illustrated example embodiment is illustrative and therefore should not be construed as being limiting in any way.

As is illustrated in FIG. 6B, the home screen 602 can include the time and/or date information 604; the signal strength information 606; the WiFi signal indicator 608; and the battery charge information 610. According to various embodiments of the concepts and technologies disclosed herein, the screen display 600B can include a shared network connection information window 620 for displaying, at the group device 114, information about the shared connection (that the group device 114 has elected to use). Thus, it can be appreciated that the screen display 600B may be presented in response to the group member selecting the UI control 614 illustrated and described above with reference to FIG. 6A. It should be understood that this example embodiment is illustrative, and therefore should not be construed as being limiting in any way.

In the embodiment shown in FIG. 6B, the shared network connection information window 620 is illustrated as indicating that the group device 114 has connected to the user device 102 to use a shared limited connectivity direct-to-cell satellite network connection (shared by the user device 102). As shown in FIG. 6B, the shared network connection information window 620 includes an available application display window 622, which can show applications that are available to the group device 114 while using the direct-to-cell satellite network connection shared by the user device 102. It should be understood that the example applications are illustrative and should not be construed as being limiting in any way. As explained above, however, the user device 102 can be configured to limit data transmissions of the group device 114 that are relayed via the shared direct-to-cell satellite network connection, and in some embodiments only certain applications (and data associated therewith) may be allowed. In some embodiments, the available application display window 622 can include selectable UI controls (e.g., for the applications) that, when selected at the group device 114, can cause the group device 114 to launch the associated application at the group device 114. It should be understood that this example embodiment is illustrative, and therefore should not be construed as being limiting in any way.

As shown in FIG. 6B, the shared network connection information window 620 can also include a UI control 624 for entering a “dismiss” option. In the embodiment shown in FIG. 6B, selection of the UI control 624 can cause the group device 114 to hide the shared network connection information window 620. It should be understood that this example embodiment is illustrative, and therefore should not be construed as being limiting in any way.

FIG. 6C shows an illustrative screen display 600C. According to some embodiments of the concepts and technologies described herein, the screen display 600C can be generated by a device such as the user device 102 via interactions with the coverage management service 116 and/or communications received from the group device 114. For example, the screen display 600C may be presented by the user device 102 in response to sending, via a peer-to-peer communication and to the group device 114, a query as to whether the group device 114 will access a shared direct-to-cell satellite network connection shared by the user device 102, and receiving a command via the peer-to-peer network 126 indicating that the group device 114 will access the shared direct-to-cell satellite network connection (e.g., via selecting the UI control 614 illustrated and described above with reference to FIG. 6A). Because the screen display 600C can be displayed at the user device 102 and/or other devices at additional and/or alternative times, it should be understood that this example embodiment is illustrative, and therefore should not be construed as being limiting in any way.

In the example screen display 600C shown in FIG. 6C, the user device 102 is illustrated as displaying a home screen 602. Because one or more elements of the screen display 600C illustrated in FIG. 6C can be displayed at additional and/or alternative times (e.g., when the user device 102 is locked), and because one or more elements of the screen display 600C may or may not be included in all embodiments, it should be understood that the illustrated example embodiment is illustrative and therefore should not be construed as being limiting in any way. As is illustrated in FIG. 6C, the home screen 602 can include the time and/or date information 604; the signal strength information 606; a WiFi signal indicator (not illustrated in FIG. 6C); a direct-to-cell satellite network status indicator 630, which can indicate that a direct-to-cell satellite network connection is available, active, and optionally an associated signal strength of the associated signal (not shown in FIG. 6C); and the battery charge information 610. It should be understood that this example embodiment is illustrative, and therefore should not be construed as being limiting in any way.

According to various embodiments of the concepts and technologies disclosed herein, the screen display 600C can include a shared network connection options window 632 for displaying, at the user device 102, information about the shared direct-to-cell satellite network connection (that the user device 102 has elected to share) and/or options for the connection sharing application 108. In the embodiment shown in FIG. 6C, the shared network connection options window 632 is illustrated as indicating that the group device 114 has requested to access the shared limited connectivity direct-to-cell satellite network connection (shared by the user device 102), along with a prompt that confirms applications that will be shared (or for which data transfers will be allowed via the shared direct-to-cells satellite connection), and a link to access options for applications and/or sharing.

As shown in FIG. 6C, the shared network connection options window 632 includes an allowed applications display window 634, which can show applications that the group device 114 can use while the group device 114 is using the direct-to-cell satellite network connection shared by the user device 102. It should be understood that the example applications are illustrative and should not be construed as being limiting in any way. As explained above, the user device 102 can be configured to limit data transmissions of the group device 114 that are relayed via the shared direct-to-cell satellite network connection, and in some embodiments only certain applications (and data associated therewith) may be allowed. Thus, the allowed applications display window 634 can provide this information to a user of the user device 102 and/or provide options for changing what applications are allowed. It should be understood that this example embodiment is illustrative, and therefore should not be construed as being limiting in any way.

As shown in FIG. 6C, the shared network connection options window 632 can also include a UI control 636 for entering a “yes” option for providing a ‘yes’ indication in response to the prompt as to whether the displayed applications are to be allowed; a UI control 638 for entering a ‘no’ option for providing a ‘no’ indication in response to the prompt as to whether the displayed applications are to be allowed; and a UI control 640 for entering an option to access options for the group devices using the shared direct-to-cell satellite network connection. In the embodiment shown in FIG. 6C, selection of the UI control 636 can cause the user device 102 to allow data associated with the applications displayed in the allowed applications display window 634 for the group device 114 while connected to the direct-to-cell satellite network connection shared by the user device 102. In the embodiment shown in FIG. 6C, selection of the UI control 638 can cause the user device 102 to block data for the group device 114 while the user device 102 is connected to the direct-to-cell satellite network connection (e.g., to cancel sharing of the direct-to-cell satellite network connection) or the like. Similarly, selection of the UI control 640 can cause the user device 102 to access one or more options associated with the connection sharing application 108 such as, for example, allowing or disallowing sharing, allowing or disallowing applications, identifying devices or users that may or may not use a shared connection, combinations thereof, or the like. It should be understood that this example embodiment is illustrative, and therefore should not be construed as being limiting in any way.

FIG. 6D shows an illustrative screen display 600D. According to some embodiments of the concepts and technologies described herein, the screen display 600D can be generated by a device such as the group device 114 via interactions with the coverage management service 116 and/or communications received from the user device 102 (e.g., a peer-to-peer communication querying the group device 114 as to whether the group device 114 will access a shared direct-to-cell satellite network connection shared by the user device 102). Because the screen display 600D can be displayed at the group device 114 and/or other devices at additional and/or alternative times, it should be understood that this example embodiment is illustrative, and therefore should not be construed as being limiting in any way.

In the example screen display 600D shown in FIG. 6D, the group device 114 is illustrated as displaying a home screen 602. Because one or more elements of the screen display 600D illustrated in FIG. 6D can be displayed at additional and/or alternative times (e.g., when the group device 114 is locked), and because one or more elements of the screen display 600D may or may not be included in all embodiments, it should be understood that the illustrated example embodiment is illustrative and therefore should not be construed as being limiting in any way. As is illustrated in FIG. 6D, the home screen 602 can include the time and/or date information 604; the signal strength information 606; the WiFi signal indicator 608; and the battery charge information 610. According to various embodiments of the concepts and technologies disclosed herein, the screen display 600D can include a shared network connection window 650 for displaying, at the group device 114, information about the shared connection (that the group device 114 has elected to use). Thus, it can be appreciated that the screen display 600D may be presented in response to the group member selecting the UI control 614 illustrated and described above with reference to FIG. 6A and therefore can correspond to an alternative embodiment for a user interface that can be presented in response to a selection of the UI control 614 of FIG. 6A. As such, it should be understood that this example embodiment is illustrative, and therefore should not be construed as being limiting in any way.

In the embodiment shown in FIG. 6D, the shared network connection window 650 is illustrated as indicating that the group device 114 has connected to the user device 102 to use a shared limited connectivity direct-to-cell satellite network connection (shared by the user device 102). As shown in FIG. 6D, the shared network connection window 650 includes a shared applications window 652, which can show applications that are being shared with the group device 114 while using the direct-to-cell satellite network connection shared by the user device 102. It should be understood that the example applications are illustrative and should not be construed as being limiting in any way.

As explained above, the user device 102 can be configured to limit data transmissions of the group device 114 via the shared direct-to-cell satellite network connection, and in some embodiments only certain applications (and data associated therewith) may be allowed. In some embodiments, the shared applications window 652 can include selectable UI controls (e.g., for the applications) that, when selected at the group device 114, can cause the group device 114 to access the associated applications for execution at the user device 102 (and display at the group device 114). It should be understood that this example embodiment is illustrative, and therefore should not be construed as being limiting in any way.

As shown in FIG. 6D, the shared network connection window 650 can also include a UI control 644 for entering a “exit” option. In the embodiment shown in FIG. 6D, selection of the UI control 644 can cause the group device 114 to hide the shared network connection window 650 and terminate the participation in the device group (i.e., to exit the device group and cancel access to the shared direct-to-cell satellite network connection). It should be understood that this example embodiment is illustrative, and therefore should not be construed as being limiting in any way.

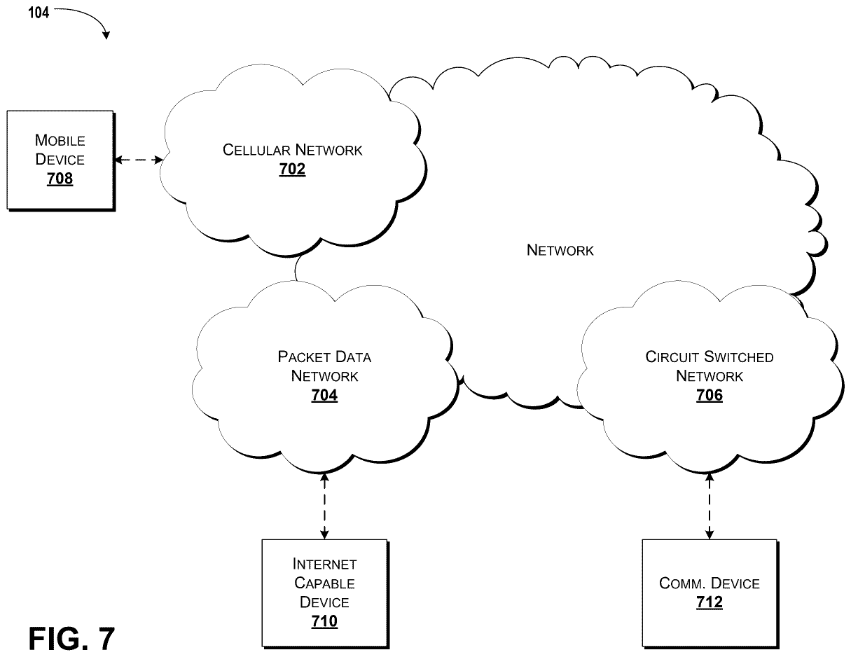

Turning now to FIG. 7, additional details of the network 104 are illustrated, according to an illustrative embodiment. The network 104 includes a cellular network 702, a packet data network 704, for example, the Internet, and a circuit switched network 706, for example, a publicly switched telephone network (“PSTN”). The cellular network 702 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 702 also can include various interfaces between various components, as is generally understood. The cellular network 702 also includes radios and nodes for receiving and transmitting voice, data, and combinations thereof to and from radio transceivers, networks, the packet data network 704, and the circuit switched network 706.

A mobile communications device 708, such as, for example, a cellular telephone, a user equipment, a mobile terminal, a PDA, a laptop computer, a handheld computer, and combinations thereof, can be operatively connected to the cellular network 702. The cellular network 702 can be configured as a 2G GSM network and can provide data communications via GPRS and/or EDGE. Additionally, or alternatively, the cellular network 702 can be configured as a 3G UMTS network and can provide data communications via the HSPA protocol family, for example, HSDPA, EUL (also referred to as HSUPA), and HSPA+. The cellular network 702 also is compatible with 4G mobile communications standards, 5G mobile communications standards, 6G mobile communication standards, other mobile communications standards, and evolved and future mobile communications standards. Moreover, the cellular network 702 may facilitate communications over various channel access methods (which may or may not be used by the aforementioned standards) including, but not limited to, TDMA, FDMA, W-CDMA, OFDM, SDMA, and the like. In addition, the cellular network 702 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 704 includes various devices, for example, servers, computers, databases, and other devices in communication with one another, as is generally known. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (POTS). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710, for example, a PC, a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710. In the specification, the network 104 is used to refer broadly to any combination of the networks 702, 704, 706. It should be appreciated that substantially all of the functionality described with reference to the network 104 can be performed by the cellular network 702, the packet data network 704, and/or the circuit switched network 706, alone or in combination with other networks, network elements, and the like.

As explained herein, the network 104 also can include and/or can access a direct-to-cell satellite network (not visible in FIG. 7). As is generally understood, a direct-to-cell satellite network can include one or more satellites (or constellations of satellites), which can be configured to communicate directly with a mobile device such as the user device 102 illustrated and described herein, which as explained herein can include and/or can be similar to the mobile communications device 708 shown in FIG. 7, a vehicle computing system (e.g., a communications device of a connected car system), and/or other devices that can use the direct-to-cell satellite network to bypass terrestrial wireless networks such as the cellular network 702 and/or some components thereof. The satellites of a direct-to-cell satellite network may be located in low earth orbit and therefore the coverage areas CAₛ of satellites of direct-to-cell satellite networks may move relative to the surface of the earth over time. Embodiments of the concepts and technologies disclosed herein can include connectivity to these and other networks as illustrated and described herein.

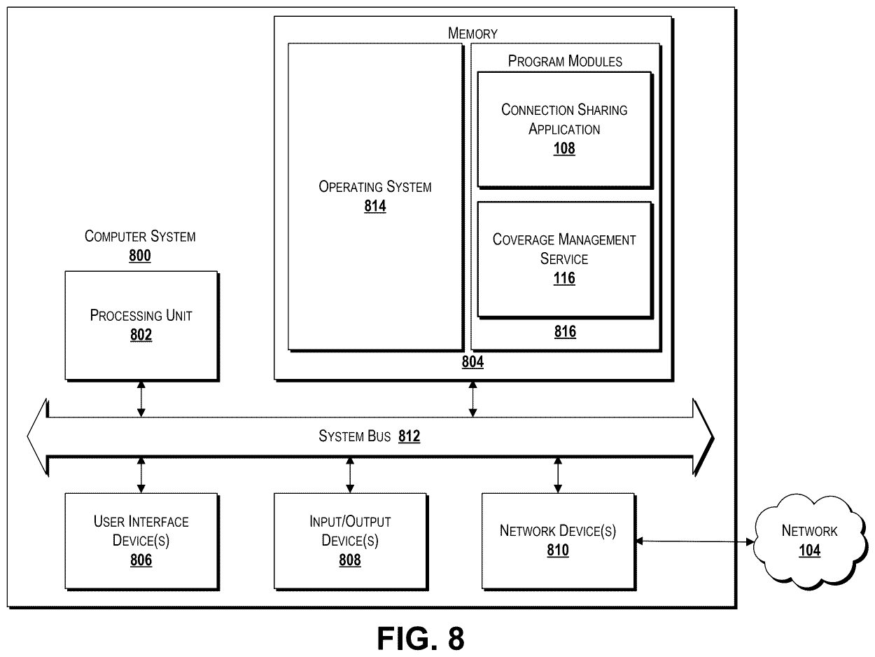

FIG. 8 is a block diagram illustrating a computer system 800 configured to provide the functionality described herein for creating and using device groups during direct-to-cell satellite coverage, in accordance with various embodiments of the concepts and technologies disclosed herein. Thus, the computer system 800 can provide, in some embodiments, one or more functions illustrated and described herein with regard to the user device 102, the group device 114, the server computer 118, the data store 124, and/or the resources 132. The computer system 800 includes a processing unit 802, a memory 804, one or more user interface devices 806, one or more input/output (“I/O”) devices 808, and one or more network devices 810, each of which is operatively connected to a system bus 812. The system bus 812 can enable bi-directional communication between the processing unit 802, the memory 804, the user interface devices 806, the I/O devices 808, and the network devices 810.

The processing unit 802 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 804 communicates with the processing unit 802 via the system bus 812. In some embodiments, the memory 804 is operatively connected to a memory controller (not shown) that enables communication with the processing unit 802 via the system bus 812. The memory 804 includes an operating system 814 and one or more program modules 816. The operating system 814 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 816 may include various software and/or program modules described herein. In some embodiments, for example, the program modules 816 can include the connection sharing application 108 and/or the coverage management service 116. These and/or other programs can be embodied in computer-readable media containing instructions that, when executed by the processing unit 802, perform one or more of the methods 200, 300, 400, and 500 described in detail above with respect to FIGS. 2-5 and/or other functionality as illustrated and described herein. It can be appreciated that, at least by virtue of the instructions embodying the methods 200, 300, 400, 500, and/or other functionality illustrated and described herein being stored in the memory 804 and/or accessed and/or executed by the processing unit 802, the computer system 800 is a special-purpose computing system that can facilitate providing the functionality illustrated and described herein. According to embodiments, the program modules 816 may be embodied in hardware, software, firmware, or any combination thereof. Although not shown in FIG. 8, it should be understood that the memory 804 also can be configured to store the device data 120, the user database 122, the group device data 128, the group data 130, the resource data 134, the command 136, and/or other data, if desired.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer storage medium” and variations thereof does not include waves or signals per se and/or communication media.

The user interface devices 806 may include one or more devices with which a user accesses the computer system 800. The user interface devices 806 may include, but are not limited to, computers, servers, personal digital assistants, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer.

The network devices 810 enable the computer system 800 to communicate with other networks or remote systems via a network, such as the network 104. Examples of the network devices 810 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

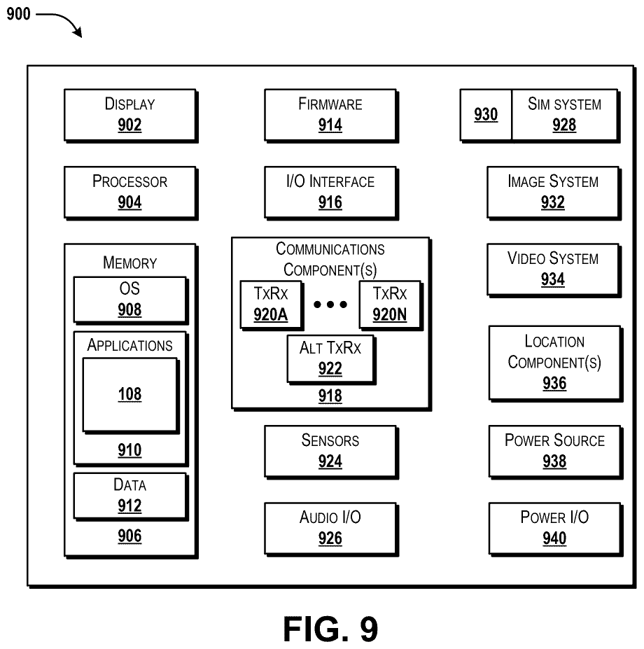

Turning now to FIG. 9, an illustrative mobile device 900 and components thereof will be described. In some embodiments, the user device 102 and/or the group device 114 described above with reference to FIGS. 1A-6D can be configured as and/or can have an architecture similar or identical to the mobile device 900 described herein in FIG. 9. It should be understood, however, that the user device 102 and/or the group device 114 may or may not include the functionality described herein with reference to FIG. 9. While connections are not shown between the various components illustrated in FIG. 9, it should be understood that some, none, or all of the components illustrated in FIG. 9 can be configured to interact with one another to carry out various device functions. In some embodiments, the components are arranged so as to communicate via one or more busses (not shown). Thus, it should be understood that FIG. 9 and the following description are intended to provide a general understanding of a suitable environment in which various aspects of embodiments can be implemented, and should not be construed as being limiting in any way.

As illustrated in FIG. 9, the mobile device 900 can include a display 902 for displaying data. According to various embodiments, the display 902 can be configured to display various graphical user interface (“GUI”) elements such as, for example, elements for indicating one or more active or available network connections, time until a network connection will be available, costs for using a network connection, limitations of a network connection, a status of network connection (e.g., active, inactive, available, unavailable, primary, secondary, etc.), text, images, video, virtual keypads and/or keyboards, messaging data, notification messages, metadata, internet content, device status, time, date, calendar data, device preferences, map and location data, combinations thereof, and/or the like. The mobile device 900 also can include a processor 904 and a memory or other data storage device (“memory”) 906. The processor 904 can be configured to process data and/or can execute computer-executable instructions stored in the memory 906. The computer-executable instructions executed by the processor 904 can include, for example, an operating system 908, one or more applications 910 such as the connection sharing application 108 and/or the coverage management service 116, other computer-executable instructions stored in a memory 906, or the like. In some embodiments, the applications 910 also can include a UI application (not illustrated in FIG. 9).

The UI application can interface with the operating system 908, such as the operating system 106 shown in FIG. 1A, to facilitate user interaction with functionality and/or data stored at the mobile device 900 and/or stored elsewhere. In some embodiments, the operating system 908 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 904 to aid a user in entering content, providing network connection status and details, configuring settings, manipulating address book content and/or settings, multimode interaction, interacting with other applications 910, and otherwise facilitating user interaction with the operating system 908, the applications 910, and/or other types or instances of data 912 that can be stored at the mobile device 900. The data 912 can include, for example, the connection sharing application 108, the coverage management service 116, and/or other applications or program modules. According to various embodiments, the data 912 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 910, the data 912, and/or portions thereof can be stored in the memory 906 and/or in a firmware 914, and can be executed by the processor 904.

It can be appreciated that, at least by virtue of storage of the instructions corresponding to the applications 910 and/or other instructions embodying other functionality illustrated and described herein in the memory 906, and/or by virtue of the instructions corresponding to the applications 910 and/or other instructions embodying other functionality illustrated and described herein being accessed and/or executed by the processor 904, the mobile device 900 is a special-purpose mobile device that can facilitate providing the functionality illustrated and described herein. The firmware 914 also can store code for execution during device power up and power down operations. It can be appreciated that the firmware 914 can be stored in a volatile or non-volatile data storage device including, but not limited to, the memory 906 and/or a portion thereof.

The mobile device 900 also can include an input/output (“I/O”) interface 916. The I/O interface 916 can be configured to support the input/output of data such as location information, history information, location information, contact information, identity data, contacts, preferences, the device data 120, the user database 122, the group device data 128, the group data 130, the resource data 134, the command 136, user information, organization information, presence status information, user IDs, passwords, and application initiation (start-up) requests. In some embodiments, the I/O interface 916 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 900 can be configured to synchronize with another device to transfer content to and/or from the mobile device 900. In some embodiments, the mobile device 900 can be configured to receive updates to one or more of the applications 910 via the I/O interface 916, though this is not necessarily the case. In some embodiments, the I/O interface 916 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 916 may be used for communications between the mobile device 900 and a network device or local device.

The mobile device 900 also can include a communications component 918. The communications component 918 can be configured to interface with the processor 904 to facilitate wired and/or wireless communications with one or more networks such as the network 104, the direct-to-cell satellite network 110, the wireless network 112, and/or other networks described herein. In some embodiments, other networks include networks that utilize non-cellular wireless technologies such as WI-FI or WIMAX. In some embodiments, the communications component 918 includes a multimode communications subsystem for facilitating communications via the cellular network and one or more other networks.

The communications component 918, in some embodiments, includes one or more transceivers. The one or more transceivers, if included, can be configured to communicate over the same and/or different wireless technology standards with respect to one another. For example, in some embodiments one or more of the transceivers of the communications component 918 may be configured to communicate using GSM, CDMAONE, CDMA 2000, LTE, and various other 2G, 2.5G, 3G, 4G, 5G, 6G, and greater generation technology standards. Moreover, the communications component 918 may facilitate communications over various channel access methods (which may or may not be used by the aforementioned standards) including, but not limited to, TDMA, FDMA, W-CDMA, OFDM, SDMA, and the like.

In addition, the communications component 918 may facilitate data communications using GPRS, EDGE, the HSPA protocol family including HSDPA, EUL or otherwise termed HSUPA, HSPA+, and various other current and future wireless data access standards. In the illustrated embodiment, the communications component 918 can include a first transceiver (“TxRx”) 920A that can operate in a first communications mode (e.g., GSM). The communications component 918 also can include an Nt^{h} transceiver (“TxRx”) 920N that can operate in a second communications mode relative to the first transceiver 920A (e.g., UMTS). While two transceivers 920A-N (hereinafter collectively and/or generically referred to as “transceivers 920”) are shown in FIG. 9, it should be appreciated that less than two, two, and/or more than two transceivers 920 can be included in the communications component 918.

The communications component 918 also can include an alternative transceiver (“Alt TxRx”) 922 for supporting other types and/or standards of communications. According to various contemplated embodiments, the alternative transceiver 922 can communicate using various communications technologies such as, for example, WiFi, WIMAX, Bluetooth, infrared, infrared data association (“IRDA”), NFC, other RF technologies, combinations thereof, and the like. In some embodiments, the communications component 918 also can facilitate reception from terrestrial radio networks, digital satellite radio networks, internet-based radio service networks, combinations thereof, and the like. The communications component 918 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 900 also can include one or more sensors 924. The sensors 924 can include temperature sensors, light sensors, air quality sensors, movement sensors, orientation sensors, noise sensors, proximity sensors, or the like. As such, it should be understood that the sensors 924 can include, but are not limited to, accelerometers, magnetometers, gyroscopes, infrared sensors, noise sensors, microphones, combinations thereof, or the like. Additionally, audio capabilities for the mobile device 900 may be provided by an audio I/O component 926. The audio I/O component 926 of the mobile device 900 can include one or more speakers for the output of audio signals, one or more microphones for the collection and/or input of audio signals, and/or other audio input and/or output devices.

The illustrated mobile device 900 also can include a subscriber identity module (“SIM”) system 928. The SIM system 928 can include a universal SIM (“USIM”), a universal integrated circuit card (“UICC”) and/or other identity devices. The SIM system 928 can include and/or can be connected to or inserted into an interface such as a slot interface 930. In some embodiments, the slot interface 930 can be configured to accept insertion of other identity cards or modules for accessing various types of networks. Additionally, or alternatively, the slot interface 930 can be configured to accept multiple subscriber identity cards. Because other devices and/or modules for identifying users and/or the mobile device 900 are contemplated, it should be understood that these embodiments are illustrative, and should not be construed as being limiting in any way.

The mobile device 900 also can include an image capture and processing system 932 (“image system”). The image system 932 can be configured to capture or otherwise obtain photos, videos, and/or other visual information. As such, the image system 932 can include cameras, lenses, charge-coupled devices (“CCDs”), combinations thereof, or the like. The mobile device 900 may also include a video system 934. The video system 934 can be configured to capture, process, record, modify, and/or store video content. Photos and videos obtained using the image system 932 and the video system 934, respectively, may be added as message content to an MMS message, email message, and sent to another mobile device. The video and/or photo content also can be shared with other devices via various types of data transfers via wired and/or wireless communication devices as described herein.

The mobile device 900 also can include one or more location components 936. The location components 936 can be configured to send and/or receive signals to determine a geographic location of the mobile device 900. According to various embodiments, the location components 936 can send and/or receive signals from global positioning system (“GPS”) devices, assisted-GPS (“A-GPS”) devices, WI-FI/WIMAX and/or cellular network triangulation data, combinations thereof, and the like. The location component 936 also can be configured to communicate with the communications component 918 to retrieve triangulation data for determining a location of the mobile device 900. In some embodiments, the location component 936 can interface with cellular network nodes, telephone lines, satellites, location transmitters and/or beacons, wireless network transmitters and receivers, combinations thereof, and the like. In some embodiments, the location component 936 can include and/or can communicate with one or more of the sensors 924 such as a compass, an accelerometer, and/or a gyroscope to determine the orientation of the mobile device 900. Using the location component 936, the mobile device 900 can generate and/or receive data to identify its geographic location, or to transmit data used by other devices to determine the location of the mobile device 900. The location component 936 may include multiple components for determining the location and/or orientation of the mobile device 900.

The illustrated mobile device 900 also can include a power source 938. The power source 938 can include one or more batteries, power supplies, power cells, and/or other power subsystems including alternating current (“AC”) and/or direct current (“DC”) power devices. The power source 938 also can interface with an external power system or charging equipment via a power I/O component 940. Because the mobile device 900 can include additional and/or alternative components, the above embodiment should be understood as being illustrative of one possible operating environment for various embodiments of the concepts and technologies described herein. The described embodiment of the mobile device 900 is illustrative, and should not be construed as being limiting in any way.

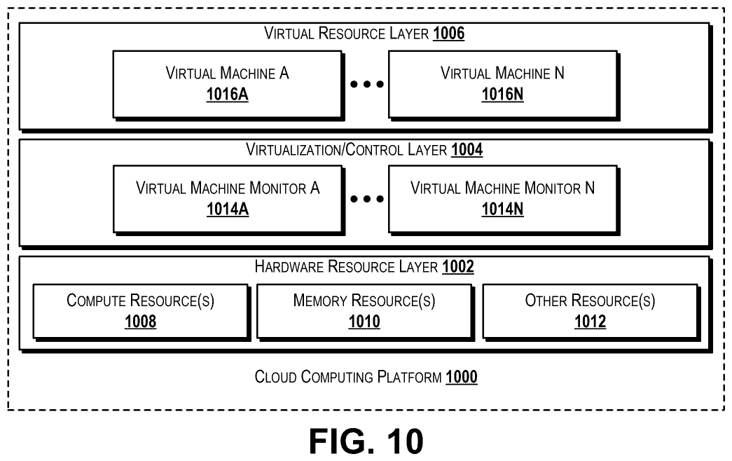

FIG. 10 illustrates an illustrative architecture for a cloud computing platform 1000 that can be capable of executing the software components described herein for creating and using device groups during direct-to-cell satellite coverage and/or for interacting with the connection sharing application 108 and/or the coverage management service 116. Thus, it can be appreciated that in some embodiments of the concepts and technologies disclosed herein, the cloud computing platform 1000 illustrated in FIG. 10 can be used to provide the functionality described herein with respect to the user device 102, the server computer 118, the group device 114, the data store 124, and/or the resources 132.

The cloud computing platform 1000 thus may be utilized to execute any aspects of the software components presented herein. Thus, according to various embodiments of the concepts and technologies disclosed herein, the connection sharing application 108 and/or the coverage management service 116 can be implemented, at least in part, on or by elements included in the cloud computing platform 1000 illustrated and described herein. Those skilled in the art will appreciate that the illustrated cloud computing platform 1000 is a simplification of but only one possible implementation of an illustrative cloud computing platform, and as such, the illustrated cloud computing platform 1000 should not be construed as being limiting in any way.

In the illustrated embodiment, the cloud computing platform 1000 can include a hardware resource layer 1002, a virtualization/control layer 1004, and a virtual resource layer 1006. These layers and/or other layers can be configured to cooperate with each other and/or other elements of a cloud computing platform 1000 to perform operations as will be described in detail herein. While connections are shown between some of the components illustrated in FIG. 10, it should be understood that some, none, or all of the components illustrated in FIG. 10 can be configured to interact with one another to carry out various functions described herein. In some embodiments, the components are arranged so as to communicate via one or more networks such as, for example, the network 104 illustrated and described hereinabove (not shown in FIG. 10). Thus, it should be understood that FIG. 10 and the following description are intended to provide a general understanding of a suitable environment in which various aspects of embodiments can be implemented, and should not be construed as being limiting in any way.

The hardware resource layer 1002 can provide hardware resources. In the illustrated embodiment, the hardware resources can include one or more compute resources 1008, one or more memory resources 1010, and one or more other resources 1012. The compute resource(s) 1008 can include one or more hardware components that can perform computations to process data, and/or to execute computer-executable instructions of one or more application programs, operating systems, services, and/or other software including, but not limited to, the connection sharing application 108 and/or the coverage management service 116 illustrated and described herein.

According to various embodiments, the compute resources 1008 can include one or more central processing units (“CPUs”). The CPUs can be configured with one or more processing cores. In some embodiments, the compute resources 1008 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 1008 can include one or more discrete GPUs. In some other embodiments, the compute resources 1008 can include one or more CPU and/or GPU components that can be configured in accordance with a co-processing CPU/GPU computing model. Thus, it can be appreciated that in some embodiments of the compute resources 1008, a sequential part of an application can execute on a CPU and a computationally-intensive part of the application can be accelerated by the GPU. It should be understood that this example is illustrative, and therefore should not be construed as being limiting in any way.

In some embodiments, the compute resources 1008 also can include one or more system on a chip (“SoC”) components. It should be understood that an SoC component can operate in association with one or more other components as illustrated and described herein, for example, one or more of the memory resources 1010 and/or one or more of the other resources 1012. In some embodiments in which an SoC component is included, the compute resources 1008 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 1008 can be or can include one or more hardware components arranged in accordance with an ARM architecture, available for license from ARM HOLDINGS of Cambridge, United Kingdom. Alternatively, the compute resources 1008 can be or can include one or more hardware components arranged in accordance with an x86 architecture, such as an architecture available from INTEL CORPORATION of Mountain View, California, and others. Those skilled in the art will appreciate the implementation of the compute resources 1008 can utilize various computation architectures and/or processing architectures. As such, the various example embodiments of the compute resources 1008 as mentioned hereinabove should not be construed as being limiting in any way. Rather, implementations of embodiments of the concepts and technologies disclosed herein can be implemented using compute resources 1008 having any of the particular computation architecture and/or combination of computation architectures mentioned herein as well as other architectures.

Although not separately illustrated in FIG. 10, it should be understood that the compute resources 1008 illustrated and described herein can host and/or execute various services, applications, portals, and/or other functionality illustrated and described herein. Thus, the compute resources 1008 can host and/or can execute the connection sharing application 108, the coverage management service 116, and/or other applications or services illustrated and described herein.

The memory resource(s) 1010 can include one or more hardware components that can perform or provide storage operations, including temporary and/or permanent storage operations. In some embodiments, the memory resource(s) 1010 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 1008, subject to the definition of “computer storage media” provided above (e.g., as excluding waves and signals per se and/or communication media as defined in this application).

Although not illustrated in FIG. 10, it should be understood that the memory resources 1010 can host or store the various data illustrated and described herein including, but not limited to, the device data 120, the user database 122, the group device data 128, the group data 130, the resource data 134, the command 136, and/or other data, if desired. It should be understood that this example is illustrative, and therefore should not be construed as being limiting in any way. The other resource(s) 1012 can include any other hardware resources that can be utilized by the compute resources(s) 1008 and/or the memory resource(s) 1010 to perform operations. The other resource(s) 1012 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 1002 can be virtualized by one or more virtual machine monitors (“VMMs”) 1014A-1014N (also known as “hypervisors;” hereinafter “VMMs 1014”). The VMMs 1014 can operate within the virtualization/control layer 1004 to manage one or more virtual resources that can reside in the virtual resource layer 1006. The VMMs 1014 can be or can include software, firmware, and/or hardware that alone or in combination with other software, firmware, and/or hardware, can manage one or more virtual resources operating within the virtual resource layer 1006.

The virtual resources operating within the virtual resource layer 1006 can include abstractions of at least a portion of the compute resources 1008, the memory resources 1010, the other resources 1012, or any combination thereof. These abstractions are referred to herein as virtual machines (“VMs”). In the illustrated embodiment, the virtual resource layer 1006 includes VMs 1016A-1016N (hereinafter “VMs 1016”).

Based on the foregoing, it should be appreciated that systems and methods for creating and using device groups during direct-to-cell satellite coverage have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A device comprising:
a processor; and
a memory that stores computer-executable instructions that, when executed by the processor, cause the processor to perform operations comprising:
detecting a current network connection of a user device, wherein the current network connection comprises a direct-to-cell satellite network connection provided by a direct-to-cell satellite network;
broadcasting, at the user device and using a peer-to-peer wireless technology, availability of a shared direct-to-cell satellite network connection;
receiving, at the user device and from a group device, a request to access the shared direct-to-cell satellite network connection, wherein the group device is located in proximity to the user device, and wherein the group device is not connected to the direct-to-cell satellite network;
in response to determining that the request to access the shared direct-to-cell satellite network connection is approved, creating a device group comprising the user device and the group device, establishing a peer-to-peer network between the user device and the group device, and sharing the shared direct-to-cell satellite network connection with the group device via the peer-to-peer network;
obtaining, by the user device and from the group device via the peer-to-peer network, group device data that corresponds to application data associated with the group device and a resource operating in communication with a network; and
sending, by the user device and directed to the resource via the direct-to-cell satellite network connection, group data that comprises the group device data.

2. The device of claim 1, wherein the computer-executable instructions, when executed by the processor, cause the processor to perform operations further comprising:
generating, at the user device, device data that comprises identity data that identifies the user device, connection data that indicates that the user device is connected to the direct-to-cell satellite network connection, and group member data that identifies the user device as a first member of the device group and the group device as a second member of the device group; and
sending, to a coverage management service and via the direct-to-cell satellite network connection, the device data, wherein the coverage management service updates a first record that is associated with the user device to include first group information that identifies the user device as the first member of the device group, and wherein the coverage management service updates a second record that is associated with the group device to include second group information that identifies the group device as the second member of the device group.

3. The device of claim 1, wherein the computer-executable instructions, when executed by the processor, cause the processor to perform operations further comprising:
obtaining, by the user device and from the group device via the peer-to-peer network, biometric data captured by biometric sensors of the group device; and
sending, by the user device and to a coverage management service via the direct-to-cell satellite network connection, the biometric data, wherein the coverage management service is configured to determine, based on the biometric data, that group traffic should be prioritized, and to deliver a command to the direct-to-cell satellite network associated with the direct-to-cell satellite network connection to prioritize the group traffic.

4. The device of claim 1, wherein the computer-executable instructions, when executed by the processor, cause the processor to perform operations further comprising:
receiving, by the user device via the direct-to-cell satellite network connection, another instance of group data that comprises other application data that is associated with the group device and the resource;
extracting, by the user device and from the other instance of group data, another instance of group device data; and
sending, by the user device and to the group device via the peer-to-peer network, the other instance of group device data.

5. The device of claim 1, wherein sending the group data directed to the resource comprises sending, by the user device and to a server computer via the direct-to-cell satellite network connection, the group data, wherein a connection management service is hosted by the server computer, and wherein the connection management service is configured to exchange communications with the resource.

6. The device of claim 1, wherein the computer-executable instructions, when executed by the processor, cause the processor to perform operations further comprising:
presenting, at the user device, a user interface that comprises an indication that the user device is connected to the direct-to-cell satellite network connection, and an option to share the direct-to-cell satellite network connection with the group device.

7. The device of claim 1, wherein the computer-executable instructions, when executed by the processor, cause the processor to perform operations further comprising:
presenting, at the user device, a user interface that comprises an indication that the user device is connected to the direct-to-cell satellite network connection, and an option to share applications with the group device, wherein the group device is configured to execute the applications and to generate data that is transmitted, by the user device, via the direct-to-cell satellite network connection.

8. A method comprising:
detecting, at a user device comprising a processor, a current network connection of the user device, wherein the current network connection comprises a direct-to-cell satellite network connection provided by a direct-to-cell satellite network;
broadcasting, at the user device and using a peer-to-peer wireless technology, availability of a shared direct-to-cell satellite network connection;
receiving, at the user device and from a group device, a request to access the shared direct-to-cell satellite network connection, wherein the group device is located in proximity to the user device, and wherein the group device is not connected to the direct-to-cell satellite network;
in response to determining that the request to access the shared direct-to-cell satellite network connection is approved, creating, by the user device, a device group comprising the user device and the group device, establishing a peer-to-peer network between the user device and the group device, and sharing the shared direct-to-cell satellite network connection with the group device via the peer-to-peer network;
obtaining, by the user device and from the group device via the peer-to-peer network, group device data that corresponds to application data associated with the group device and a resource operating in communication with a network; and
sending, by the user device and directed to the resource via the direct-to-cell satellite network connection, group data that comprises the group device data.

9. The method of claim 8, further comprising:
generating, at the user device, device data that comprises identity data that identifies the user device, connection data that indicates that the user device is connected to the direct-to-cell satellite network connection, and group member data that identifies the user device as a first member of the device group and the group device as a second member of the device group; and
sending, to a coverage management service and via the direct-to-cell satellite network connection, the device data, wherein the coverage management service updates a first record that is associated with the user device to include first group information that identifies the user device as the first member of the device group, and wherein the coverage management service updates a second record that is associated with the group device to include second group information that identifies the group device as the second member of the device group.

10. The method of claim 8, further comprising:
obtaining, by the user device and from the group device via the peer-to-peer network, biometric data captured by biometric sensors of the group device; and
sending, by the user device and to a coverage management service via the direct-to-cell satellite network connection, the biometric data, wherein the coverage management service is configured to determine, based on the biometric data, that group traffic should be prioritized, and to deliver a command to the direct-to-cell satellite network associated with the direct-to-cell satellite network connection to prioritize the group traffic.

11. The method of claim 8, further comprising:
receiving, by the user device via the direct-to-cell satellite network connection, another instance of group data that comprises other application data that is associated with the group device and the resource;
extracting, by the user device and from the other instance of group data, another instance of group device data; and
sending, by the user device and to the group device via the peer-to-peer network, the other instance of group device data.

12. The method of claim 8, further comprising:
presenting, at the user device, a user interface that comprises an indication that the user device is connected to the direct-to-cell satellite network connection, and an option to share the direct-to-cell satellite network connection with the group device.

13. The method of claim 8, further comprising:
presenting, at the user device, a user interface that comprises an indication that the user device is connected to the direct-to-cell satellite network connection, and an option to share applications with the group device, wherein the group device is configured to execute the applications and to generate data that is transmitted, by the user device, via the direct-to-cell satellite network connection.

14. A computer storage medium having computer-executable instructions stored thereon that, when executed by a processor, cause the processor to perform operations comprising:
detecting a current network connection of a user device, wherein the current network connection comprises a direct-to-cell satellite network connection provided by a direct-to-cell satellite network;
broadcasting, at the user device and using a peer-to-peer wireless technology, availability of a shared direct-to-cell satellite network connection;
receiving, at the user device and from a group device, a request to access the shared direct-to-cell satellite network connection, wherein the group device is located in proximity to the user device, and wherein the group device is not connected to the direct-to-cell satellite network;
in response to determining that the request to access the shared direct-to-cell satellite network connection is approved, creating a device group comprising the user device and the group device, establishing a peer-to-peer network between the user device and the group device, and sharing the shared direct-to-cell satellite network connection with the group device via the peer-to-peer network;
obtaining, by the user device and from the group device via the peer-to-peer network, group device data that corresponds to application data associated with the group device and a resource operating in communication with a network; and
sending, by the user device and directed to the resource via the direct-to-cell satellite network connection, group data that comprises the group device data.

15. The computer storage medium of claim 14, wherein the computer-executable instructions, when executed by the processor, cause the processor to perform operations further comprising:
generating, at the user device, device data that comprises identity data that identifies the user device, connection data that indicates that the user device is connected to the direct-to-cell satellite network connection, and group member data that identifies the user device as a first member of the device group and the group device as a second member of the device group; and
sending, to a coverage management service and via the direct-to-cell satellite network connection, the device data, wherein the coverage management service updates a first record that is associated with the user device to include first group information that identifies the user device as the first member of the device group, and wherein the coverage management service updates a second record that is associated with the group device to include second group information that identifies the group device as the second member of the device group.

16. The computer storage medium of claim 14, wherein the computer-executable instructions, when executed by the processor, cause the processor to perform operations further comprising:
obtaining, by the user device and from the group device via the peer-to-peer network, biometric data captured by biometric sensors of the group device; and
sending, by the user device and to a coverage management service via the direct-to-cell satellite network connection, the biometric data, wherein the coverage management service is configured to determine, based on the biometric data, that group traffic should be prioritized, and to deliver a command to the direct-to-cell satellite network associated with the direct-to-cell satellite network connection to prioritize the group traffic.

17. The computer storage medium of claim 14, wherein the computer-executable instructions, when executed by the processor, cause the processor to perform operations further comprising:
receiving, by the user device via the direct-to-cell satellite network connection, another instance of group data that comprises other application data that is associated with the group device and the resource;
extracting, by the user device and from the other instance of group data, another instance of group device data; and
sending, by the user device and to the group device via the peer-to-peer network, the other instance of group device data.

18. The computer storage medium of claim 14, wherein sending the group data directed to the resource comprises sending, by the user device and to a server computer via the direct-to-cell satellite network connection, the group data, wherein a connection management service is hosted by the server computer, and wherein the connection management service is configured to exchange communications with the resource.

19. The computer storage medium of claim 14, wherein the computer-executable instructions, when executed by the processor, cause the processor to perform operations further comprising:
presenting, at the user device, a user interface that comprises an indication that the user device is connected to the direct-to-cell satellite network connection, and an option to share the direct-to-cell satellite network connection with the group device.

20. The computer storage medium of claim 14, wherein the computer-executable instructions, when executed by the processor, cause the processor to perform operations further comprising:
presenting, at the user device, a user interface that comprises an indication that the user device is connected to the direct-to-cell satellite network connection, and an option to share applications with the group device, wherein the group device is configured to execute the applications and to generate data that is transmitted, by the user device, via the direct-to-cell satellite network connection.
